(19) United States
(12) Patent Application Publication
(10) Pub. No.: US 2026/0281943 A1
(43) Pub. Date: Sep. 17, 2026

(54) MULTIPATH TIME AND CARRIER PHASE POSITIONING

(71) Applicant: Telefonaktiebolaget LM Ericsson (publ), Stockholm (SE)

(72) Inventors: Edwin IUN, Ottawa (CA); Roland SMITH, Nepean (CA); Colin PUCHALA, Kanata (CA)

(21) Appl. No.: 19/163,276

(22) PCT Filed: Mar. 10, 2023
(86) PCT No.: PCT/IB2023/052308

§ 371 Date: Sep. 8, 2025

(51) Int. Cl. H04W 64/00; G01S 5/02; G01S 5/14

(52) U.S. Cl. CPC H04W 64/00; G01S 5/0252; G01S 5/0273; G01S 5/14; G01S 2205/02

(57) ABSTRACT

According to some embodiments, a method is performed by a network node for determining a location of a wireless device. The method includes obtaining a location of an antenna reference point (ARP) within a venue and calculating locations of virtual ARPS (vARPs). The locations of the vARPs are based on the location of the ARP and a geometry of the venue. The method further includes: calculating a channel impulse response (CIR) from a radio signal transmitted by a wireless device; extracting line-of-sight (LoS) and non-line-of-sight (nLoS) components from the CIR; associating the LoS component with the ARP and the nLoS components with the vARPs; generating a set of possible locations for the wireless device based on a measurement of the LoS component and measurements of the nLoS components; and selecting one location from the set of possible locations for the wireless device.

### TECHNICAL FIELD

Embodiments of the present disclosure are directed to wireless communications and, more particularly, to multipath time and carrier phase positioning for a wireless device in a wireless network.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Fifth generation (5G) wireless networks are rapidly expanding. Accurate device positioning is a key enabler for many vertical applications, such as public safety and indoor navigation. A benefit of cellular-based positioning, which complements the existing Global Navigation Satellite Systems (GNSS), is that cellular-based positioning works well both outdoors and indoors.

Some positioning technologies include Third Generation Partnership Project (3GPP) 5G New Radio (NR) positioning and sensor fusion, such as GNSS, motion sensors, and/or a barometer for vertical positioning). Some outdoor positioning technologies include GNSS with time delay and time of flight (TOF). GNSS may be enhanced for ultra-precise positioning using real time kinetic (RTK). Another outdoor positioning technology includes observed time difference of arrival (OTDOA). 5G NR uses new positioning reference signals. Some indoor technologies include Bluetooth Low Energy (BLE) and WiFi based positioning using beacons and received signal strength indicator (RSSI) and/or angle of arrival (AoA). Ultra-wideband (UWB) technologies may use TOF relative to at least three anchor positions for precision of 10-30 centimeters.

3GPP Release 16 supports multi-/single-cell and device-based positioning, defining a new positioning reference signal (PRS) used by various 5G positioning techniques, such as roundtrip time (RTT), angle of arrival/departure (AoA/AoD), and time difference of arrival (TDOA). An example is illustrated in FIG. 1.

FIG. 1 is a block diagram illustrating multi-cell positioning. These techniques are designed to meet initial 5G requirements of three and ten meters for indoor and outdoor use cases, respectively. In Release 17, precise indoor positioning functionality will bring sub-meter accuracy applicable for industrial IoT use cases.

Although the description above is based on 5G, the techniques used can be implemented by other radio frequency technologies as well.

High accuracy user equipment (UE) positioning for cellular systems that achieve accuracies in the meter range generally demand propagation time delay techniques of the radio frequency signals to assess the location. Measurements determine either the absolute time it takes a signal to travel from a transmitter to a receiver, referred to as time of flight, or the relative time it takes a signal to travel from a transmitter to a receiver, referred to as time difference of arrival.

Because the UE transmitter and network antenna reference point (ARP) radio receivers are in different locations with non-identical frames of time reference, the precise transmission time is often not known. Positioning algorithms leverage the relative time of arrival at different receivers to determine location. This type of positioning is referred to as time difference of arrival (TDoA) and is commonly used to generate a set of hyperbolic equations whose intersection defines the UE location. Techniques for TDoA are well known and require knowledge of the (x, y, z) locations of the antenna reference point receivers, as well as the TDoA measurements. TDoA measurements can be performed by the network, such as Uplink Time Difference of Arrival (UTDoA) or performed by the UE, such as Observed Time Difference of Arrival (OTDoA), where relative time of arrival measurements are made by the UE and subsequently reported to the network to calculate the UE location.

Time-of-arrival (ToA), also referred to as time-of-flight (ToF), makes absolute measurements of the propagation time between transmitter and receiver. The process is the same as above, except that it typically measures the round-trip-time (RTT) which is divided by two to approximate the one-way ToF delay. Similar to other positioning techniques, estimation of the UE positioning is typically performed by the network which has knowledge of the ARP antennas used in each of the ToF measurements. While ToF is most often measured in the network, it can be measured by the UE. Absolute positioning has the advantage that it generates actual propagation measurements, which are directly converted into speed of light distances of ToF*300 meters per microsecond. Because the UE distance to each ARP is known from the ToF measurements, this type of positioning generates circles around each ARP, whose intersection defines the UE location.

The above techniques are well known and with good calibration and reliable measurements from three or four antenna reference points for ToA/ToF/RTT or TDoA/OTDoA respectively, the UE location can be determined. For ToA/ToF/RTT, three ARP measurements are required to locate the UE as the intersection of three non-concentric circles. For TDoA/OTDoA, four ARP measurements are required. The first measurement is used as a “reference” and subtracted from the other measurements to generate three TDoA measurements. The UE is found at the intersection of three hyperbolic curves.

The techniques described above (ToA/ToF/TDoA/OTDoA) work only when there are multiple ARPs. They require multiple ARPs to determine location. Using ToA or ToF, one ARP defines a circle where the UE may be located, two ARPs define two intersection points and three ARPs define a single location in two-dimensional space (i.e. x, y). Four ARPs with ToA or ToF can generally resolve a UE location in three-dimensional (3D) space. In a similar way, using TDoA and OTDoA assigning one ARP as a zero time reference, then 2, 3, 4, and 5 ARPs are needed to resolve the UE location to (2) a hyperbola, or (3) at two points on the hyperbola, (4) at a 2D (x, y) point on the hyperbola, and (5) for 3D (x, y, z) positioning using UTDoA/OTDoA.

These techniques are employed in many industries and rely on multiple ARP measurements, and therefore a high density of deployed antennas. Ultra-wide-band (UWB) technologies that deliver high performance positioning using proprietary transmitters and receivers often deploy ARPs at a density of one every 10m, enabling measurements to be made at multiple antennas points, many of which may be line of sight for improved accuracy. UWB systems are deployed for high accuracy positioning and have developed technologies such as cable integrated ARPs for rapid infrastructure installation, ensuring the availability of multiple ARPs on a 10 meter grid throughput a venue.

Cellular networks follow a different paradigm and are driven by lowest cost of coverage resulting in typical ARP spacings of 30 meters or more where the primary focus is connectivity. ARPs are more expensive, providing multi-band operation and high transmit power, and with a spacing of 30 meters or more, the ARP density is an order of magnitude lower than equivalent UWB systems. Network design software tools are often used to optimize the locations of the cellular ARPs to guarantee customer coverage and performance targets, often placing one or two ARPs to cover a room or floor area.

While a higher density of ARPs is possible by setting different parameters on the network design software tools, the end result is a significant increase in deployment costs with extra ARPs added on an as needed basis to ensure that all locations within the venue can make timing measurements to at least 3 or 4 ARPs.

Placements of ARPs is important, but they are not always ideal. Geometric factors such as dilution of precision further exasperate the issue because ARPs are placed closer to the outer walls of the coverage area so that resulting hyperbolic or circular curves have a greater probability to intersect each other orthogonally.

The concept of dilution of precision (DOP) originated with users of the Loran-C navigation system. The idea of Geometric DOP is to state how errors in the measurement will affect the final state estimation.

FIG. 2 includes two graphs, (a) and (b), illustrating dilution of precision. Ideally, small changes in the measured data will not result in large changes in output location, as illustrated in graph (a) of FIG. 2. However, DOP happens when the ARPs are close together on the same side, as illustrated in graph (b) of FIG. 2. When the ARPs are positioned as in graph (b), the system is sensitive to measurement errors.

The sensitivity to measurement errors is undesirable because it translates to positioning error. Unfortunately, this is typical of an indoor deployment when all the ARPs are on the ceiling or along a wall.

Indoor positioning challenges include the following. Positioning in wireless networks is a challenge owing to the mobility of users and the dynamic nature of both the environment and radio signals. Positioning quality of service (QoS) is typically defined in terms of accuracy, confidence level, latency, and the time for obtaining a positioning result.

Assisted-Global Positioning System (A-GPS) or GPS-capable devices could be a solution to rising user expectations and to meeting the more stringent requirements imposed by regulators and organizations. While many new mobile devices are likely to be equipped with GPS receivers, numerous devices that lack such receivers remain in use and offering GPS-capable handsets at no cost to subscribers does not solve the problem either, because no single positioning method, including GPS, works well in all environments. GPS, for example, fails to provide a reasonable level of positioning accuracy in indoor and urban canyon environments.

The indoor deployment of ARPs is also a challenge. As described above with respect to dilution of precision, the ARPs are typically installed on the ceiling and around the center of a room. When the ceiling is high, all the ARP measurements are not separated by a large angle, therefore DOP is prominent, and it is a major challenge.

Indoor networks are also susceptible to multipath. Multipath is the incoherent combination of signals that travel by more than one route from a transmitter and arrive at different times at the receiver. It is created by the returned reflections or scattering of the original signal that are combined at the receiver. These reflections occur when the signal bounces from the various surfaces within the indoor environment. These reflected signals of the same spectral frequency arrive at the receiver with varying time delay, which depends on the reflection path that they travelled. As a result, the received signal may be buried by the delayed versions of the original signal as they randomly arrive and combine at the receiver.

FIG. 3 is a top-down view of an indoor multipath example. In the illustrated example of an indoor structure (e.g., office, warehouse, etc.), the bold arrow represents the line-of-sight (LoS) signal, and dashed arrows represent the reflected signals that are reflected by the walls of the structure.

In traditional positioning methods, there are two main reasons why multipath is seen as being detrimental. One reason is that the multipath can interfere with the extraction of the line-of-sight signal that is used in traditional positioning technologies. The signals can interfere destructively and thus weaken the line-of-sight signal at the receiver. Another reason is that multipath signals take different paths and thus take longer to arrive at the receiver, and therefore cannot be used to determine the UE position.

For these reasons, much effort is made to identify and filter the multipath signals so that position estimates can be made reliably using only the line-of-sight ToA information.

In outdoor environments, multipath may be caused by atmospheric ducting, ionospheric refractions, reflections from bodies of water, geological structures, and buildings.

Indoor multipath are mainly caused by the building structure including ceilings, walls, furniture, and floors. The strength of the multipath will be determined by the materials used in construction in the indoor environment.

FIG. 4 is a side view of an indoor multipath example. In this example, the radio transmitter is mounted near the ceiling. As with respect to FIG. 3, the bold arrow represents the line of sight signal, and dashed arrows represent the reflected signals that are reflected by the walls, ceiling, and/or floors of the structure. As illustrated, a UE may receive many multipath signals, even in a simple indoor environment.

The z-axis accuracy is also becoming more important. The Federal Communications Commission (FCC) adopted rules in 2015 that commercial wireless carriers would have to provide vertical location, or z-axis, information in the top 25 Cellular Market Areas by Apr. 3, 2021, and that the information must be accurate to within three meters of the device's position. In particular, the requirement is deploying z-axis technology to cover 80% of the population, or alternatively to cover 80% of buildings.

The three-meter accuracy may be adequate for a first responder use case. A higher resolution facilitates more use case realization such as Industry 4.0, equipment tracking and drone control.

Recent proposals in indoor positioning combine beamforming angles (θ) and ToA/RTT measured distance (r) to determine the UE location using polar coordinates. In theory, these techniques can determine UE positioning with a single ARP; however, accuracy depends on beamforming and ToA resolution. Besides, indoor deployment covers a small geographical area; therefore, beam forming which has benefit of capacity increase could be used when the situation calls for. NR UE support is limited to four streams, therefore, there is little value for a cellular ARP to support more than four antennas, severely limiting angular (θ) resolution and making this methodology less desirable. Null pointing is possible with few antennas, but is counter to carrying cellular traffic, and suffers from non-LoS reflections.

Thus, there currently exist certain challenges. For example, current cellular technology has no viable means to perform high accuracy time base positioning with low ARP densities, where UE locations may be seen by one or two ARPs. Using current technology, it is not possible to track an object without the number of ARPs being greater than the dimensional space of the object being tracked. For example, to track an object in 3D space, the system shall require at least four ARPs.

Recent work in indoor positioning makes use of multipath matrices (previously an undesirable interference) to eliminate the costly requirement of additional ARPs. Some solutions use virtual anchors, as described in Cooperative Localization and Tracking using Multipath Channel Information, Josef Kulmer, et. al, Graz University of Technology, Austria, as a means to improve positioning estimates using multipath components to assist indoor navigation and tracking. The paper describes an UWB system using cooperative and non-cooperative measurements made by the one or more receiver “agents” using multipath components to estimate position. An example is illustrated in FIG. 5.

FIG. 5 is a floorplan illustrating multipath propagation and virtual anchors. In the illustrated example, the solution uses time alignment of agent m denoted as p^{(m)} and a virtual anchor of agent m denoted as p₂^{(m)} enabling line of sight to be assessed at agent m, and non-LoS (multipath component) from the virtual anchor of agent m to be assessed at agent m′ (i.e., a co-operative receiver).

While this paper describes the concept of a virtual anchor defined by the geometry of the building, as well as the time alignment of the signal launch from agent m and the virtual anchor of agent m, it models the diffuse multipath (DM) from the virtual anchor as an independent zero-mean Gaussian random process. Positioning estimates are then calculated as independent, but time aligned channel impulse responses by detecting the peak of the power delay profiles of the line-of-sight and non-line of sight components. While this technique was reaching a position accuracy better than 6 cm for 90% of the measurement points, they were achieved using an UWB signal bandwidth of approximately 2 GHz generated from a 0.5 ns “pulse” as the transmission source, coupled with significant Kalman filtering of measurements. The solution described in the paper used pulsed signals, not a carrier, and does not describe the aspects associated with carrier phase, or multipath differential carrier phase. In other words, the method described in the paper cannot be extended in a 3GPP cellular system environment.

A second paper, Indoor Positioning using Time Difference of Arrival between Multipath Components, Christian Gentner and Thomas Jost, German Aerospace Center (DLR), Institute of Communications and Navigation, describes multipath aided positioning by using the time difference of arrival between multipath components (TDoAbMC). An example is illustrated in FIG. 6.

FIG. 6 illustrates multipath propagation between a transmitter and a receiver. In the illustrated example, the multipath propagation of the wireless signal is used to facilitate positioning when there is an insufficient number of transmitters or increase the accuracy otherwise. Range estimates use the estimated channel impulse response (CIR) to remove the influence on the estimate of the line-of-sight path delay by using the time difference of arrival between multipath components (TDoAbMC).

The solution described in the second paper treats the channel impulse responses (CIR) amplitude α_{v,i}(tₖ) as a real function with respect to discrete time tₖ, where v is the received antenna in a multiple-input multiple-output (MIMO) receiver, and i is the multipath component from that antenna. While the second paper presents the concept of a virtual transmitter, as well a means to use multipath components to determine time difference of arrival, it does not consider the carrier phase, nor any of the implications of this derivative function such as carrier phase differences.

The assumptions of zero mean Bayesian statistics also omit the impact of near in multipath which causes significant biases not present in the use of carrier phase invalidating many of the results in the second paper.

### SUMMARY

Based on the description above, certain challenges currently exist with positioning for wireless devices in a wireless network. Certain aspects of the present disclosure and their embodiments may provide solutions to these or other challenges. For example, particular embodiments introduce carrier phase to the concept of virtual antenna reference points (ARPs) used to calculate the dominant multipath reflections from these points to use for time-based positioning. In additions, particular embodiments introduce carrier phase difference of arrival to multipath components to address cases where carrier phase has drift for which it may not be possible to compensate.

Traditionally, multipaths were treated as impediments. Particular embodiments convert the negative multipath impediment into positive contribution to achieve high precision positioning. Particular embodiments facilitate locating a UE using a single ARP, not previously considered possible.

Particular embodiments enable time-based positioning techniques, either absolute ToA/ToF/RTT or relative TDoA/OTDoA to augment real ARP measurements with virtual ARP measurements. This technique enables carrier phase techniques, including carrier phase difference of arrival.

While ToA techniques measure the first signal arrival time or line-of-sight (LoS) arrival component of the channel impulse response (CIR) seen at the actual ARP, particular embodiments measure various non-LoS components in the CIR and map them onto virtual ARPs. While achieving good accuracy, it does not deliver high precision; therefore, the particular embodiments estimate carrier phase for each of the measured multipath components, enabling carrier phase of arrival positioning, or carrier phase difference of arrival when carrier phase is changing too rapidly for accurate estimation or reporting.

Particular embodiments treat non-LoS multipath reflections as LoS signals from virtual ARPs, extracting multiple timing and carrier phase measurements from a single CIR. An advantage of particular embodiments is measuring multipath signals and applying them in underdetermined positioning use cases where a venue is covered by only one or two real ARPs.

Particular embodiments use virtual ARPs to enhance positioning timing measurements to mitigate dilution of precision errors common in perimeter coverage regions. Particular embodiments mirror real ARPs as virtual ARPs thereby extending available timing and carrier phase measurements outside of the perimeter of the room or building.

Particular embodiments use virtual ARPs to improve z-axis positioning, mirroring real ARP locations providing floor coverage to the floors above and below using multipath and carrier phase discernment.

In general terms, particular embodiments include virtual antenna reference points and process multipath for time and carrier phase positioning. Leveraging multipath time of arrival and multipath time difference of arrival, particular embodiments include extraction and application of estimated multipath carrier phase, translating good time of arrival accuracy into high precision carrier phase positioning.

Particular embodiments use multipath carrier phase measurements with time of arrival (ToA) measurements from channel impulse responses (CIR). According to some embodiments, there are two ways of calculating the carrier phase of the multipath component in the CIR described as peak or integrated phases, as preferred means to estimate carrier phase. Particular embodiments apply calculated carrier phase measurements against virtual ARP locations. Particular embodiments process the measured carrier phase of multipath components to yield carrier phase difference of arrivals measurements enabling carrier phase to be used even when the transmitter phase is unknown or changing too rapidly to be estimated.

Particular embodiments use floor plan and physical ARP locations to optimize the placement of ARP locations and calculate/optimize the associated virtual ARP pairs. Using the received radio frequency signal by the ARP from a wireless mobile equipment, Particular embodiments generate possible locations of the wireless mobile equipment.

Some embodiments eliminate false solutions. Particular embodiments combat (1) dilution of precision, (2) z-axis low resolution, (3) inadequate number of ARP for the dimension of interest and (4) insufficient line-of-sight ARP in a deployment. In some embodiments, if a single solution is not arrived in a first iteration, a supplemental data point may be used to arrive at a singular solution.

Particular embodiments extend the state of the art of positioning, and more precisely multipath positioning, beyond traditional time of arrival (ToA) and time difference of arrival (TDoA) teachings to a higher level with carrier phase positioning, and carrier phase difference of arrival positioning. The latter facilitates tracking wireless mobile equipment where the carrier phase is rapidly changing with respect to the ARP and virtual ARP receivers.

These examples illustrate the benefits and significant improvements using virtual ARPs, each with estimated time of arrival and carrier phase multipath components.

According to some embodiments, a method is performed by a network node for determining a location of a wireless device. The method comprises obtaining a location of an ARP within a venue and calculating locations of one or more vARPs. The locations of the one or more vARPs are based on the location of the ARP and a geometry of the venue. The method further comprises: calculating a CIR from a radio signal transmitted by a wireless device; extracting LOS and one or more nLoS components from the CIR; associating the LoS component with the ARP and the one or more nLoS components with the one or more vARPs; generating a set of one or more possible locations for the wireless device based on a measurement of the LoS component and measurements of the one or more nLoS components; and selecting one location from the set of one more possible locations for the wireless device.

In particular embodiments, the method further comprises determining a carrier phase associated with the LoS component and carrier phases associated with one or more of the nLoS components. Generating the set of one or more possible locations for the wireless device is further based on the carrier phase associated with the LoS component and the carrier phases associated with one or more of the nLoS components.

In particular embodiments, the measurement associated with the LoS component and the measurements associated with one or more of the nLoS components comprises a time of flight (ToF) measurement, or a time difference of arrival (TDoA) measurement.

In particular embodiments, selecting one location from the set of one or more possible locations for the wireless device is based on a signal strength associated with one or more of the nLoS components. In some embodiments, selecting one location from the set of one or more possible locations for the wireless device comprises excluding possible solutions that locate the wireless device outside of the venue or excluding possible solutions that locate the wireless device within restricted areas of the venue. In some embodiments, selecting one location from the set of one or more possible locations for the wireless device is based on a previously determined location of the wireless device or finger printing of the wireless device. In some embodiments, selecting one location from the set of one or more possible locations for the wireless device comprises receiving measurement information from a second ARP.

In particular embodiments, the locations of one or more virtual ARPs with respect to the venue is further based on a construction material of the venue.

In particular embodiments, the method further comprises transmitting an indication of the selected location of the wireless device to another network node.

According to some embodiments, another method is performed by a network node for determining a location of a wireless device. The method comprises obtaining a location of an ARP within a venue and calculating locations of one or more vARPs. The locations of the one or more vARPs are based on the location of the ARP and a geometry of the venue. The method further comprises: calculating a CIR from a radio signal transmitted by a wireless device; extracting a carrier phase of a LOS and one or more nLoS components from the CIR; associating the carrier phase of the LoS component with the ARP and the carrier phase of the one or more nLoS components with the one or more vARPs; generating a set of one or more possible locations for the wireless device based on the carrier phase of the LoS component and the carrier phase of the one or more nLoS components; and selecting one location from the set of one more possible locations for the wireless device.

In particular embodiments, the method further comprises determining a measurement associated with the LoS component and measurements associated with one or more of the nLoS components. Generating the set of one or more possible locations for the wireless device is further based on the measurement associated with the LoS component and the measurements associated with one or more of the nLoS components.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments are fully 3GPP compliant and do not require additional hardware equipment.

Cost reduction is another benefit. Indoor cellular networks typically consist of common equipment located in a communications room or closet in a building or office, and distributed equipment, often installed on ceilings throughout the venue coverage zones. Ethernet may be used to connect common equipment with distributed radio end points, directly or through switches. Power over Ethernet or local power outlet powers the active radios, referred to as antenna reference points. Particular embodiments use fewer physical ARPs (as low as one antenna) by using virtual ARPs, reducing network cost.

Particular embodiments have performance benefits, mitigating dilution of precision (DoP) issues which occur outside the perimeter of physical ARPs used to provide indoor coverage, such as large office floors or factory floors. DoP is a well understood issue resulting from ARP location geometry.

Particular embodiments improve the z-axis accuracy that regulatory bodies are mandating. Also, particular embodiments are able to locate an object in a non-ideal environment with fewer line-of-sight ARPs. High positioning precision with reduced numbers of ARPs is a benefit. Time of arrival techniques give good positioning accuracy, and while ToA of multipath components for virtual ARPs also gives good accuracy for reduced physical ARPs, carrier phase measurements have higher precision.

In particular embodiments, estimating the carrier phase difference of arrival of multipath components may be used with transmitted signals, such as from wireless user equipment, where the carrier is often changing rapidly with respect to the ARPs and cannot be estimated.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram illustrating multi-cell positioning;

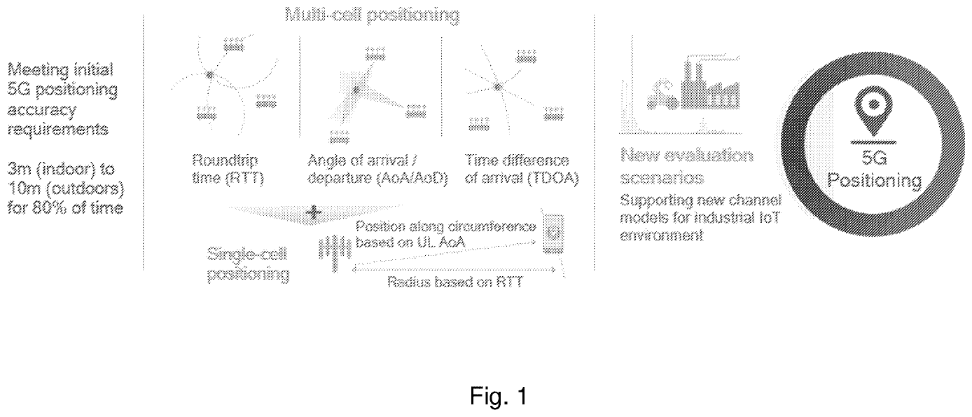

FIG. 2 includes two graphs, (a) and (b), illustrating dilution of precision;

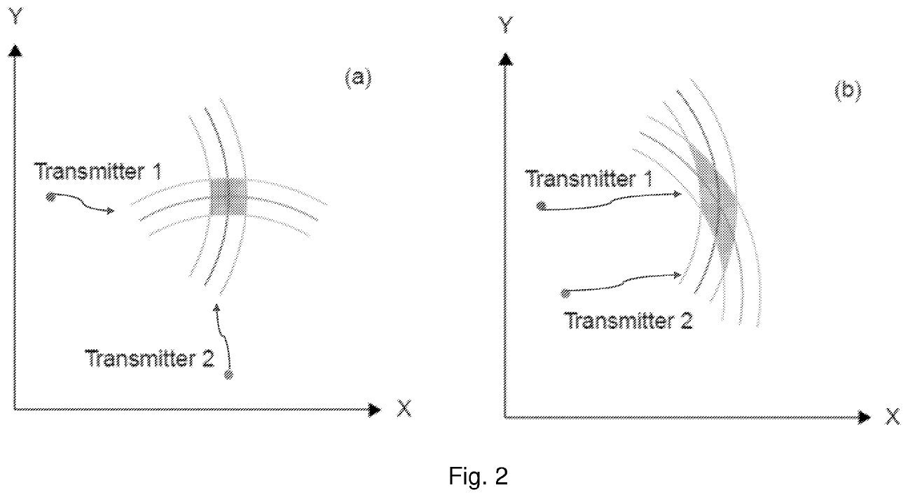

FIG. 3 is a top-down view of an indoor multipath example;

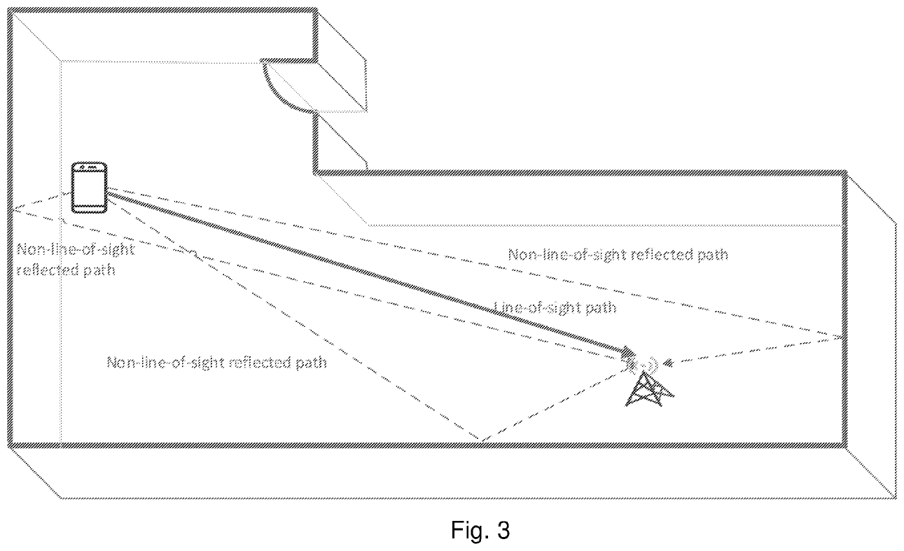

FIG. 4 is a side view of an indoor multipath example;

FIG. 5 is a floorplan illustrating multipath propagation and virtual anchors;

FIG. 6 illustrates multipath propagation between a transmitter and a receiver;

FIG. 7 is an overhead view of a rectangular room with a single antenna reference point at location (x, y) excluding the z-dimension for simplicity;

FIG. 8 is an overhead view of a rectangular room with a single antenna reference point, four virtual antenna points, and a line-of-sight (LoS) path;

FIG. 9 is an overhead view of a rectangular room with a single antenna reference point, four virtual antenna points, and one multipath reflection;

FIG. 10 is an overhead view of a rectangular room with a single antenna reference point, four virtual antenna points, one LoS path and four multipath reflections;

FIG. 11 is a graph illustrating the measured channel impulse response for the example illustrated in FIG. 10;

FIG. 12 is an overhead view of a rectangular room with a plot lines for a LoS signal;

FIG. 13 is an overhead view of a rectangular room with plot lines for the LoS signal and one multipath signal;

FIG. 14 is an overhead view of a rectangular room with plot lines for the LoS signal and four multipath signals;

FIG. 15 is a close-up view of the intersecting plot lines at the UE location illustrated in FIG. 14;

FIG. 16 is an overhead view of a rectangular room with plot lines for one LoS and four multipath signals where the assignment of multipath signal to a virtual ARP is unknown;

FIG. 17 is an overhead view of the rectangular room illustrated in FIG. 16 with a subset of the illustrated plot lines removed using RANSAC;

FIG. 18 is a close-up illustration of the dominant intersection points illustrated in FIG. 17;

FIG. 19 is an overhead view of a structure with a single ARP showing use of floor plan geometry, movement estimation and finger printing;

FIG. 20 is an overhead view of a rectangular room with plot lines for one LOS and two multipath signals with two intersection points;

FIG. 21 is an overhead view of a rectangular room with plot lines for one LoS and two multipath signals with two intersection points and an additional ARP;

FIG. 22 is an overhead view of a rectangular room illustrating dilution of precision;

FIG. 23 is an overhead view of a portion of a room with two ARPs parallel to a wall;

FIG. 24 is a side view of a portion of a room with two ARPs mounted to the ceiling;

FIG. 25 is a graph illustrating channel impulse response in carrier phase positioning;

FIG. 26 is a graph illustrating a carrier phase positioning example;

FIG. 27 is a block diagram illustrating an example wireless network positioning system, according to particular embodiments;

FIG. 28 is a flowchart illustrating an example positioning method, according to particular embodiments;

FIG. 29 is block diagram illustrating a distributed position algorithm in a cloudified wireless signal processor;

FIG. 30 is a block diagram illustrating a centralized position algorithm in a cloudified wireless signal processor;

FIG. 31 is a block diagram illustrating a position algorithm in a wireless signal processor at the network edge;

FIG. 32 is a block diagram illustrating a position algorithm in a cloudified location server;

FIG. 33 is a block diagram illustrating a position algorithm in a cloudified central unit of wireless signal processor;

FIG. 34 is a block diagram illustrating an example position algorithm in an O-RAN environment;

FIG. 35 is a block diagram illustrating an example wireless network, according to particular embodiments;

FIG. 36 illustrates an example user equipment, according to certain embodiments;

FIG. 37A is a flowchart illustrating an example method in a network node, according to certain embodiments;

FIG. 37B is a flowchart illustrating another example method in a network node, according to certain embodiments; and

FIG. 38 illustrates a schematic block diagram of a wireless device and a network node in a wireless network, according to certain embodiments.

### DETAILED DESCRIPTION

Based on the description above, certain challenges currently exist with positioning for wireless devices in a wireless network. Certain aspects of the present disclosure and their embodiments may provide solutions to these or other challenges. For example, particular embodiments include virtual antenna reference points (ARPs) and process multipath for time and carrier phase positioning. Leveraging multipath time of arrival and multipath time difference of arrival, particular embodiments include extraction and application of estimated multipath carrier phase, translating good time of arrival accuracy into high precision carrier phase positioning.

Particular embodiments will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Although particular problems and solutions may be described using new radio (NR) terminology, it should be understood that the same solutions apply to long term evolutions (LTE) and other wireless networks as well, where applicable.

Particular embodiments include virtual ARPs and time and carrier phase-based positioning. An antenna reference point is a network antenna with a known (x, y, z) location typically defined using Global Positioning System (GPS) coordinates that is used in the positioning process. Uplink and downlink positioning relies on ARP location information, which combined with radio frequency propagation times, is used to define a set of circles or hyperbolas, respectively, for absolute or relative time of arrival measurements.

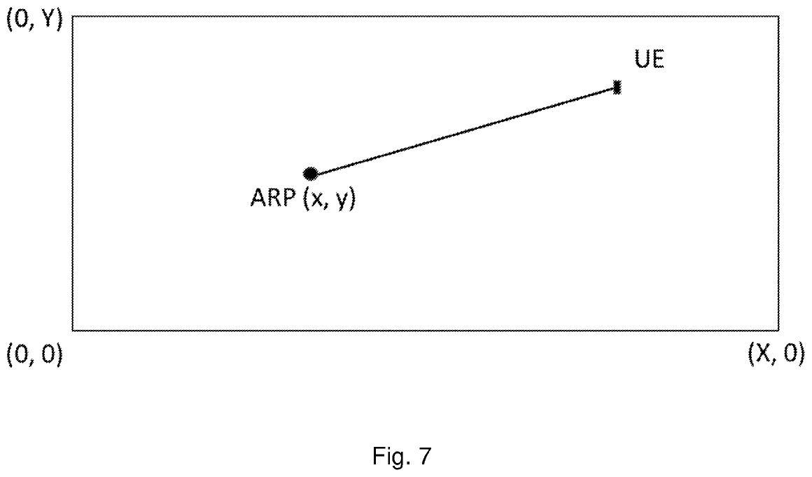

FIG. 7 is an overhead view of a rectangular room with a single antenna reference point at location (x, y) excluding the z-dimension for simplicity. A grid is assigned to the room, with (0, 0) at the lower left corner, (X, 0) at the lower right corner, and (0, Y) at the upper left corner. Also illustrated is a user equipment (UE) in the room.

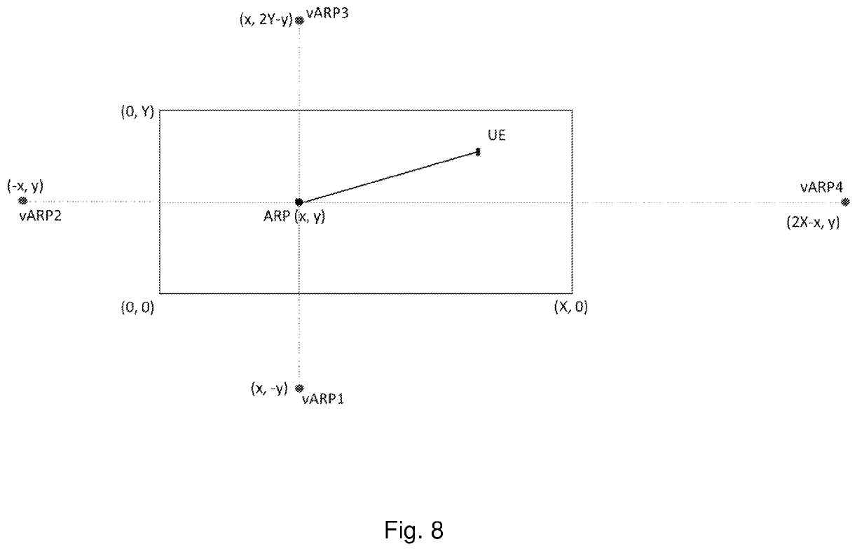

FIG. 8 is an overhead view of a rectangular room with a single antenna reference point and four virtual antenna points. As illustrated, four virtual ARPs are defined as mirror images of the ARP to the wall. Virtual ARP1, labelled vARP1 in FIG. 8, is located at (x, −y) symmetrically mirrored against the wall which extends from (0, 0) to (X, 0). Following the same methodology, vARP2, vARP3 and vARP4 are defined at their respective mirrored locations of (−x, y), (x, 2Y−y) and (2X−x, y).

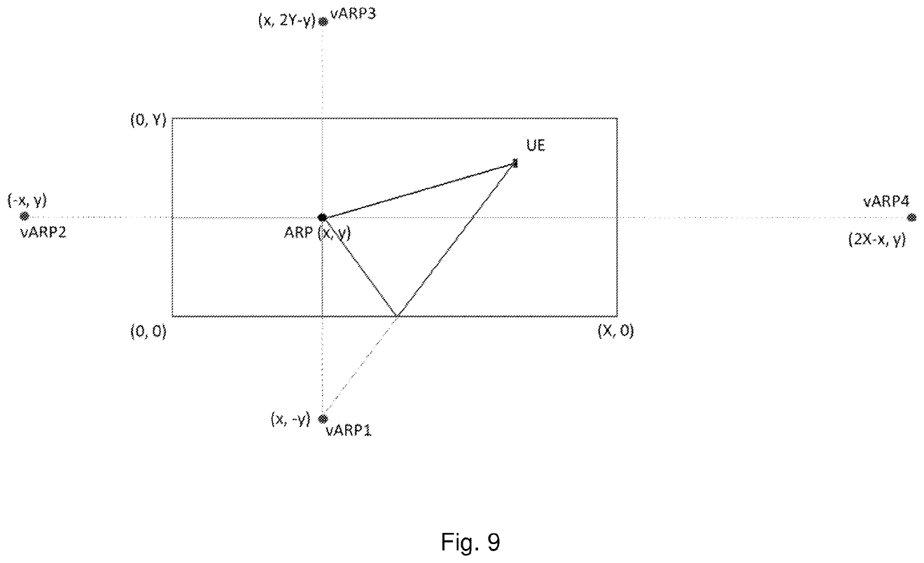

FIG. 9 is an overhead view of a rectangular room with a single antenna reference point, four virtual antenna points, and one multipath reflection. As illustrated, a line is drawn between vARP1 and the UE. The intersection of the line and the wall defines the location where a strong multipath reflection results from ARP transmissions.

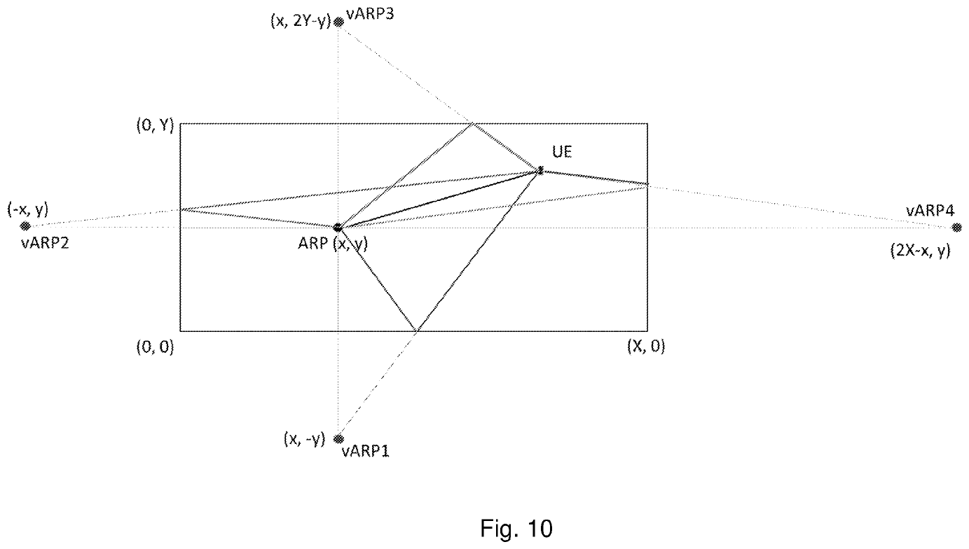

FIG. 10 is an overhead view of a rectangular room with a single antenna reference point, four virtual antenna points, one LoS path, and four multipath reflections. Extending the concept illustrated in FIG. 9, similar multipath reflections can be determined for vARP2, vARP3 and vARP4. Wall intersections define locations of dominant multipath reflections from ARP transmissions.

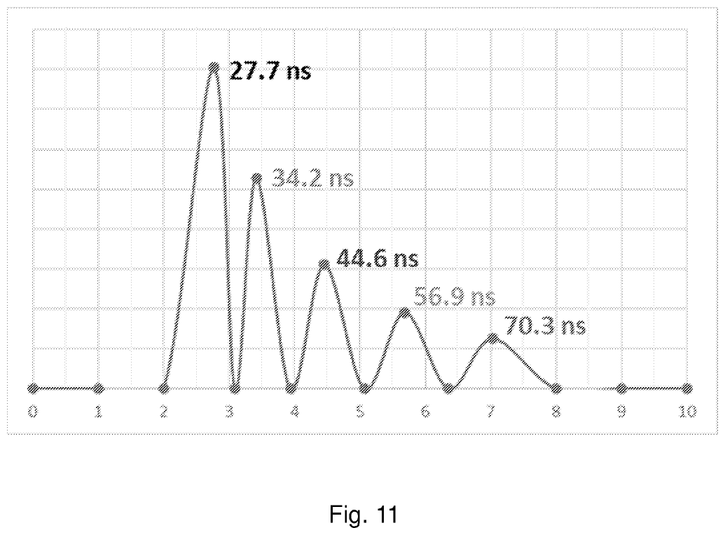

FIG. 11 is a graph illustrating the measured channel impulse response for the example illustrated in FIG. 10. The illustrated example shows absolute timing measurements with a CIR with LoS path at 27.7 ns and dominant multipaths at 34.2 ns, 44.6 ns, 56.9 ns and 70.3 ns. The ARP to UE LoS path is the shortest at 27.7 ns.

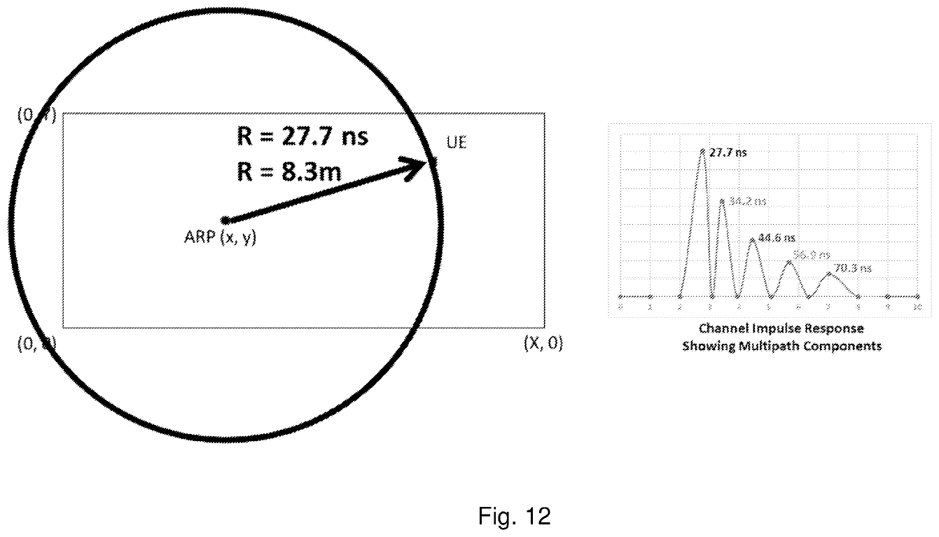

Multipath measurements can be mapped onto each of the real and virtual ARPs. An example is illustrated in FIG. 12.

FIG. 12 is an overhead view of a rectangular room with a plot line for a LoS signal. The LoS signal was 27.7 ns representing a circle with radius 27.7 ns=8.3 m intersecting the UE.

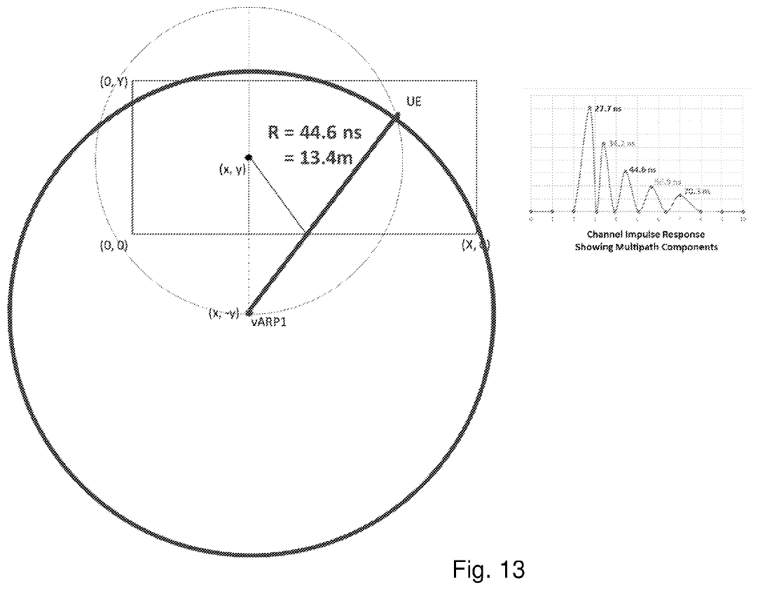

A similar circle can be drawn at vARP1 with a radius of 44.6 ns measured from the CIR, representing a 13.4 m radius. This absolute measurement also intersects the UE location. An example is illustrated in FIG. 13.

FIG. 13 is an overhead view of a rectangular room with plot lines for the LoS signal and one multipath signal. The two circles intersect at two locations, one of which represents the location of the UE.

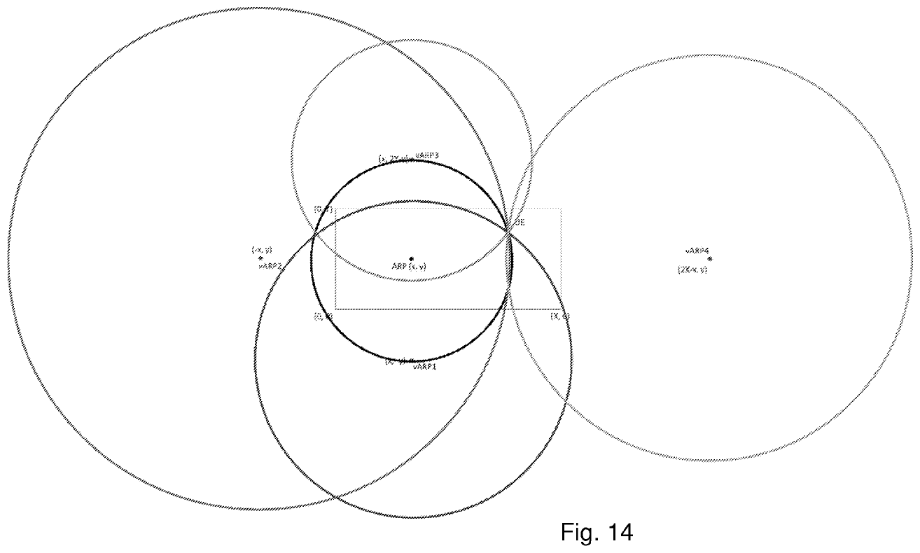

The remaining dominant peaks in the channel impulse response function are used to draw multiple circles, each of which intersects the UE location. An example is illustrated in FIG. 14.

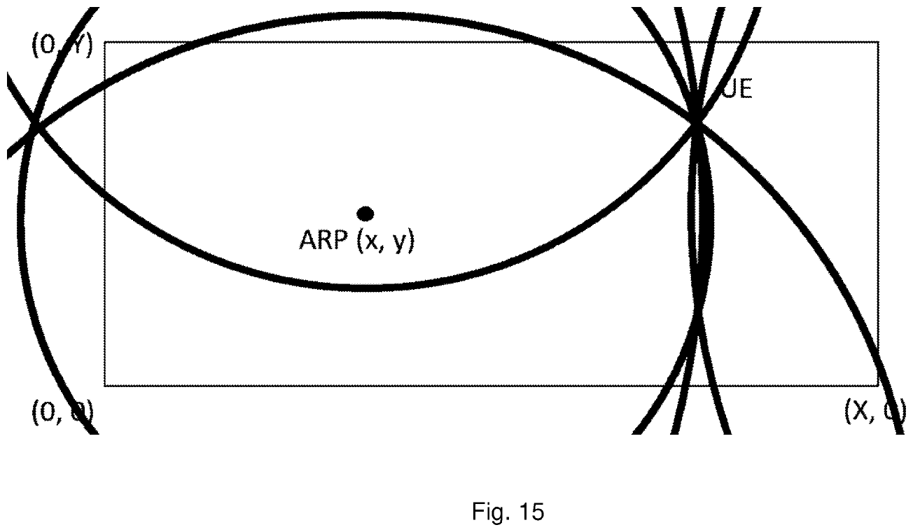

FIG. 14 is an overhead view of a rectangular room with plot lines for the LoS signal and four multipath signals. Only at the UE do all absolute timing radius measurements intersect. FIG. 15 is a close-up view of the intersecting plot lines at the UE location illustrated in FIG. 14.

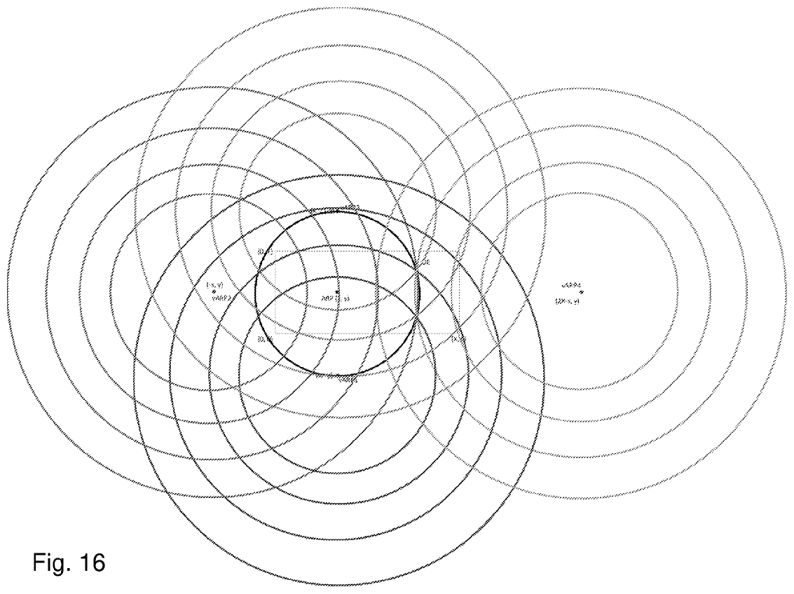

The example above assumes absolute timing information can be measured, allowing circles of known distances to be drawn from the ARP and virtual ARP locations. This example makes a key assumption of assignment of multipath component to virtual ARP. If the assignment is unknown, the resulting solution may have more than one result, requiring additional processing and information to determine the UE location. An example is illustrated in FIG. 16.

FIG. 16 is an overhead view of a rectangular room with plot lines for one LOS and four multipath signals where the assignment of multipath signal to a virtual ARP is unknown. Because the assignment is unknown, four circles are drawn around each virtual ARP location.

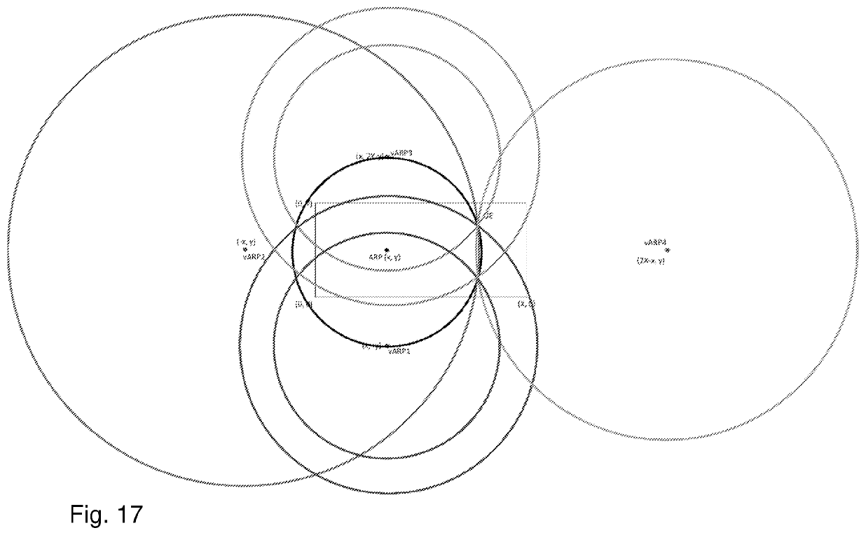

Random sample consensus (RANSAC) may be used to eliminate all ToA circles with three or fewer intersections, leaving a subset showing two dominant and symmetrical intersection points within the positioning area. An example is illustrated in FIG. 17.

FIG. 17 is an overhead view of the rectangular room illustrated in FIG. 16 with a subset of the illustrated plot lines removed using RANSAC. The two dominant intersection points include five intersections.

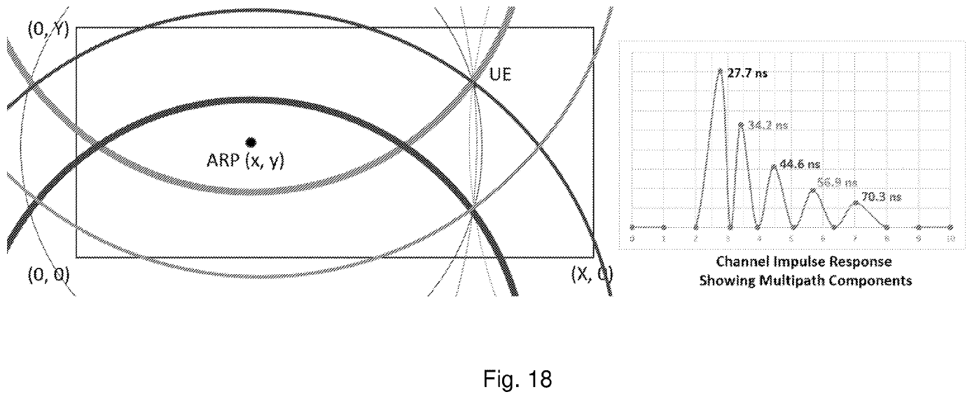

Additional information may be used to discern the UE location, such as the use of measurement signal strength where the 34.2 ns time of arrival has a greater signal strength than the 44.6 ns arrival time. This is especially true when the reflective coefficients of the wall materials are different, or the geometry of the room floorplan is an irregular shape. An example is illustrated in FIG. 18.

FIG. 18 is a close-up illustration of the dominant intersection points illustrated in FIG. 17. The width of the each plot line represents the measured signal strength. The UE is located at the intersection point where the 34.2 ns plot line is strongest.

In this example, the UE location was determined with a single real ARP combined with timing measurements of four virtual ARPs, highlighting the potential for false readings. RANSAC was used to eliminate all circles with three or fewer intersection points. Finally, measurement signal strength was used to determine the correct intersection of the two remaining solutions. It is possible that a singular solution can be arrived in this case.

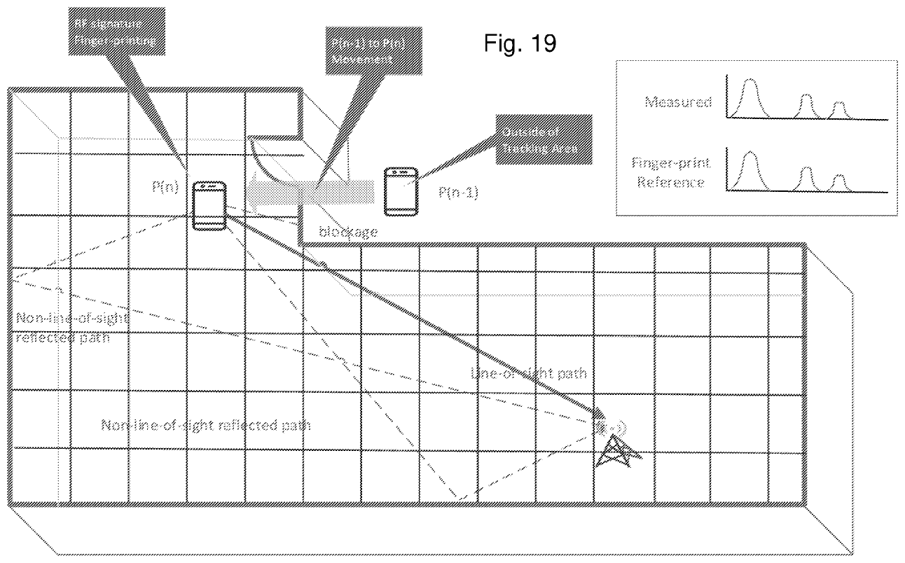

Some embodiments include additional methods to reduce the number of possible solutions. For example, some embodiments may use geofencing, Kalman filtering, and/or fingerprinting. An example is illustrated in FIG. 19.

FIG. 19 is an overhead view of a structure with a single ARP showing use of floor plan geometry, movement estimation and finger printing. In the illustrated example, the UE location was determined with a single real ARP combined with its virtual ARPs. Some solutions can be eliminated because: (a) they fall outside the parameters of the room (e.g., geofencing); (b) the position at time “n” P(n) can be resolved with Kalman filter and the previous location P(n−1); and/or (c) a prior collection of finger printing increases the confidence of the solution.

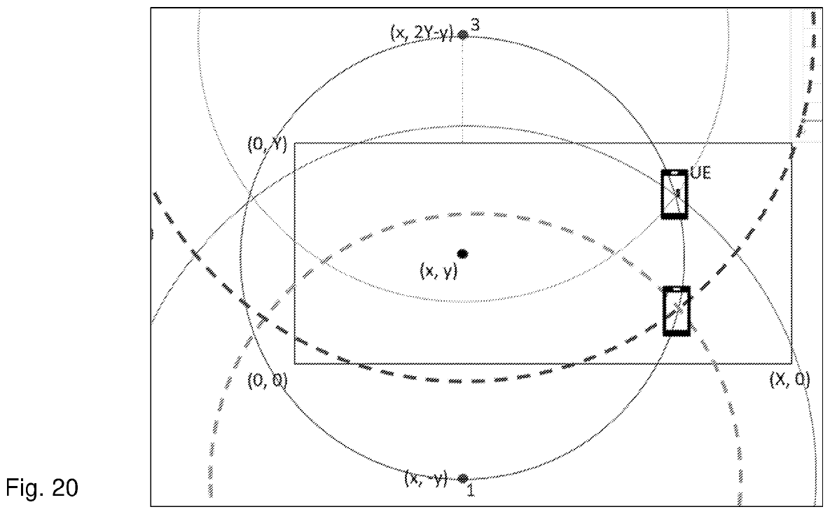

Some embodiment include ambiguity resolution with one or more references. An example is illustrated in FIG. 20.

FIG. 20 is an overhead view of a rectangular room with plot lines for one LoS and two multipath signals with two intersection points. The UE location was determined with a single real ARP combined with timing measurements of two virtual ARPs. There are solutions that fall outside the parameters of the room and therefore they are rejected. There is more than one possible solution and the task is to find out which one is the correct solution.

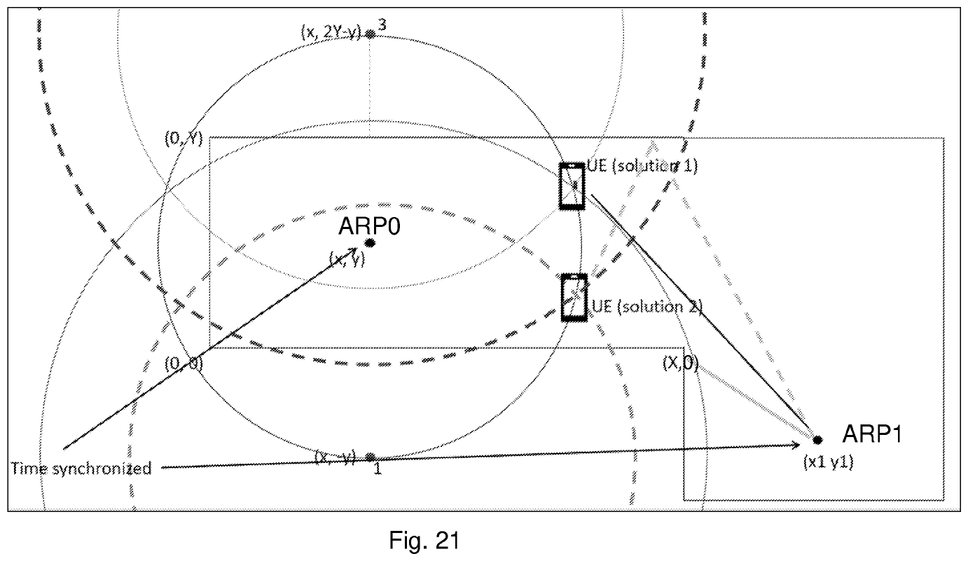

FIG. 21 is an overhead view of a rectangular room with plot lines for one LoS and two multipath signals with two intersection points and an additional ARP. The first ARP (ARP0) may use information from the second ARP (ARP2) to discern which of the two possible locations illustrated in FIG. 20 is the actual location of the wireless device.

For example, ARP0 and ARP1 are time synchronized in the system. The two solutions are made to pass through the cross-examination of the ARP1 measurement. In the illustrated example, the time-of-arrival of solution 1 and solution 2 are different. Using this additional information, it is possible to conclude the true location of the UE.

ARP0 and ARP1 may exchange information, either directly, or via another network node, such as a core network node and/or location server.

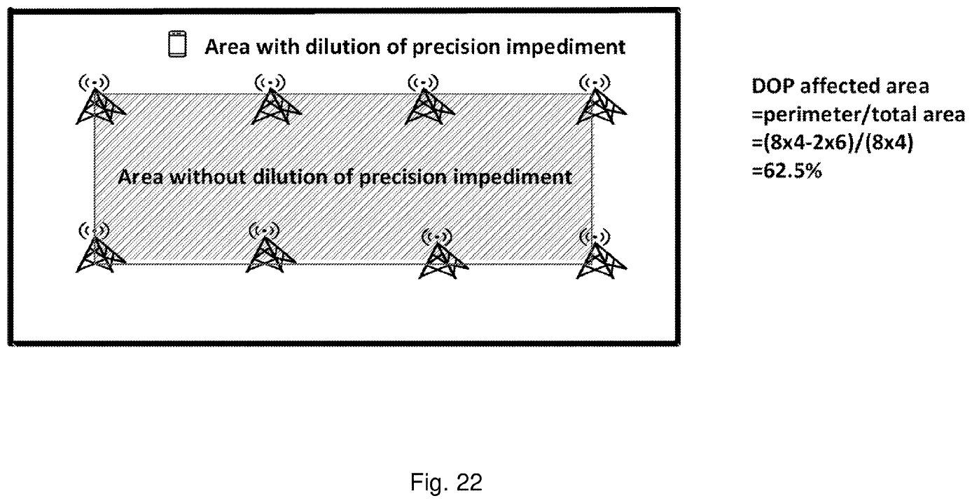

Some embodiments include resolution of dilution of precision. Dilution of precision is a common problem in an indoor deployment. An example is illustrated in FIG. 22.

FIG. 22 is an overhead view of a rectangular room illustrating dilution of precision. ARPs are typically arranged as shown in FIG. 22 to provide maximum cell coverage. In the illustrated pattern, overlap among ARPs is minimized to use the fewest number of ARPs to limit cost. However, the perimeter areas suffer from dilution of precision and are extremely sensitive to measurement error. This is an artifact because all the ARPs are on one side of the User Equipment as explained above in the Background. Calculating the area affected by dilution of precision, 62.5% of the room area is non-ideal. Therefore, solving this problem dramatically improves the overall system performance and reduces measurement uncertainty including the corner areas.

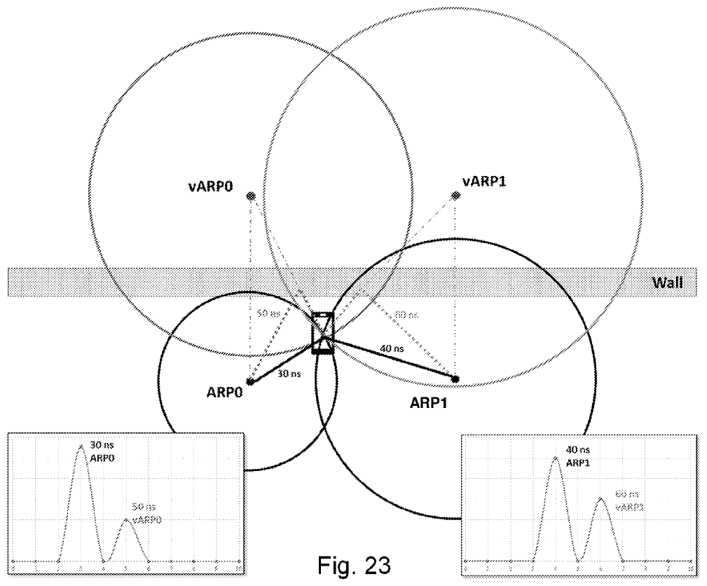

A common case involves two real ARPs and two virtual ARPs such as the example illustrated in FIG. 23.

FIG. 23 is an overhead view of a portion of a room with two ARPs parallel to a wall. In the illustrated example, channel impulse responses are measured at ARP0 and ARP1, each of which has a mirrored vARP.

In the illustrated example, the UE location is readily determined by measuring the LoS paths seen by real ARP0 and ARP1 of 30 ns and 40 ns respectively. Their associated virtual ARPs multipaths are 50 ns and 60 ns respectively, enabling 4 circles to be determined, the intersection of which locates the UE.

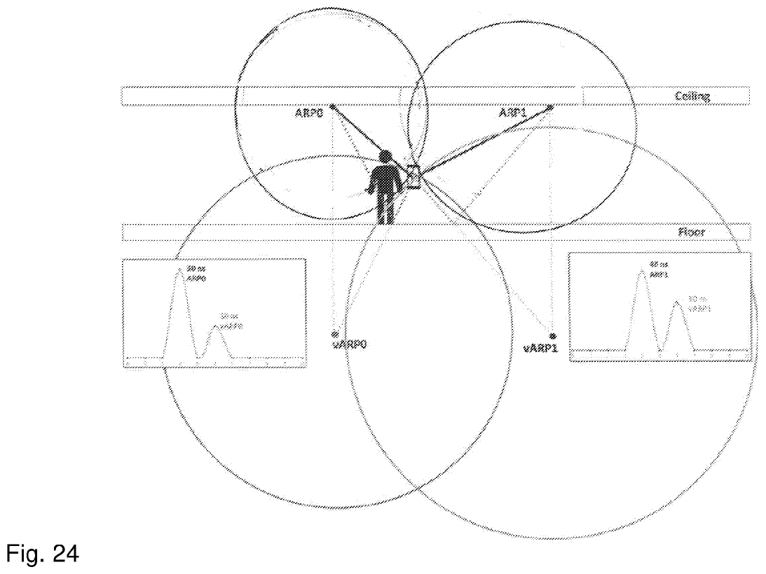

Some embodiment include Z-axis positioning. For example, some embodiments use virtual ARPs through the floor to improve UE location z-axis (height) determination. An example is illustrated in FIG. 24.

FIG. 24 is a side view of a portion of a room with two ARPs mounted to the ceiling. The illustrated example is similar to the example in FIG. 23, with ARP0/ARP1 located on the ceilings and vARP0/vARP1 located below the floor.

Some embodiment include relative positioning. For simplicity, the examples described herein have used time-of-flight (ToF) to explain particular concepts. They were represented by concentric circles around the ARPs. The same concept can be extended to time-difference-of-arrival (TDoA). The circles in the illustrated examples may be replaced by parabolas, but the principle remains the same.

Some embodiments include carrier phase positioning. Particular embodiments extend the measurement of time of arrival of multipath components to include carrier phase of these components.

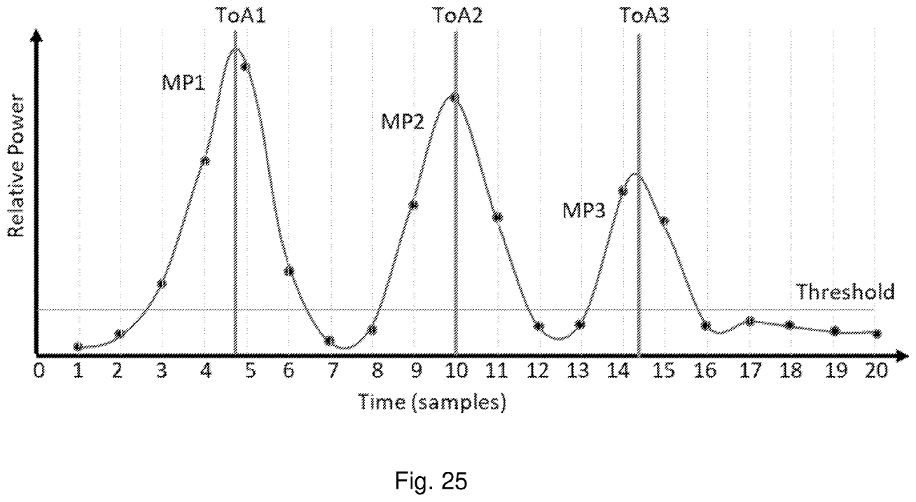

FIG. 25 is a graph illustrating channel impulse response in carrier phase positioning. The horizontal axis represents time and the vertical axis represents relative power.

The illustrated example channel impulse response includes three multipath components: MP1, MP2, and MP3 and calculated time of arrivals: ToA1, ToA2, and ToA3. An algorithm may differentiate multipath components with any arbitrary threshold as described below.

There are multiple means to estimate the time of arrivals of the various peaks through interpolation or other similar functions to generate high precision ToA estimates. From estimated ToA values, typically the first LoS peak (ToA1) is selected as a reference and used to calculate various time difference of arrivals as TDoA1=(ToA2−ToA1), TDoA2=(ToA3−ToA1), etc.

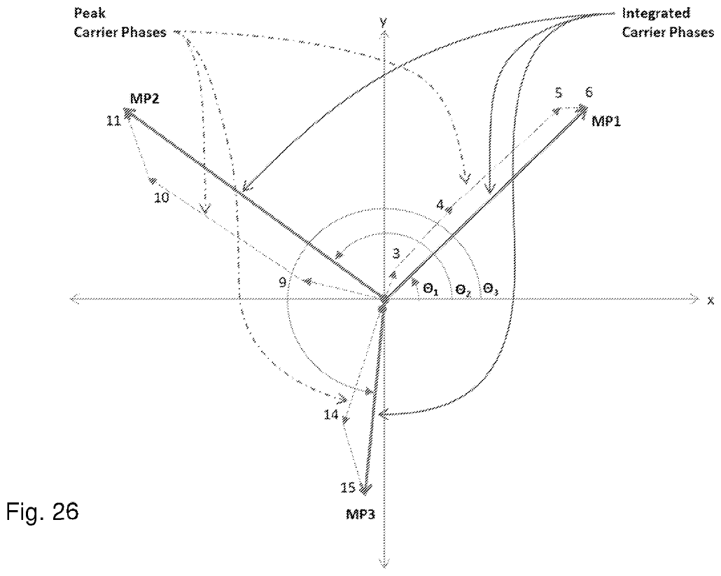

Carrier phase of the CIR multipaths can be calculated in multiple ways. An example is illustrated in FIG. 26.

FIG. 26 is a graph illustrating a carrier phase positioning example. The carrier phase of MP1 is illustrated as θ₁ and is calculated as a vector sum of the CIR at sample points 3, 4, 5, and 6. The sum weights the contribution of the samples in a multipath component by the relative power (x²+y²)^{1/2} of the sample. A good approximation to the integrated phase θ₁ is to use the phase of the peak power of MP1, illustrated as vector 5, which is the CIR phase at sample 5. Those skilled in the art can conceive similar measurements for carrier phase.

The illustrated example shows MP1, MP2 and MP3 as well as the calculated vectors and vector sums used to calculate the carrier phases θ₁, θ₂, and θ₂ respectively. These carrier phase values may be used to calculate the carrier phase difference of arrival as CPDoA1=(θ₂−θ₁), CPDoA2=(θ₃−θ₁), etc., where one carrier phase, in this case θ₁, is used as a reference.

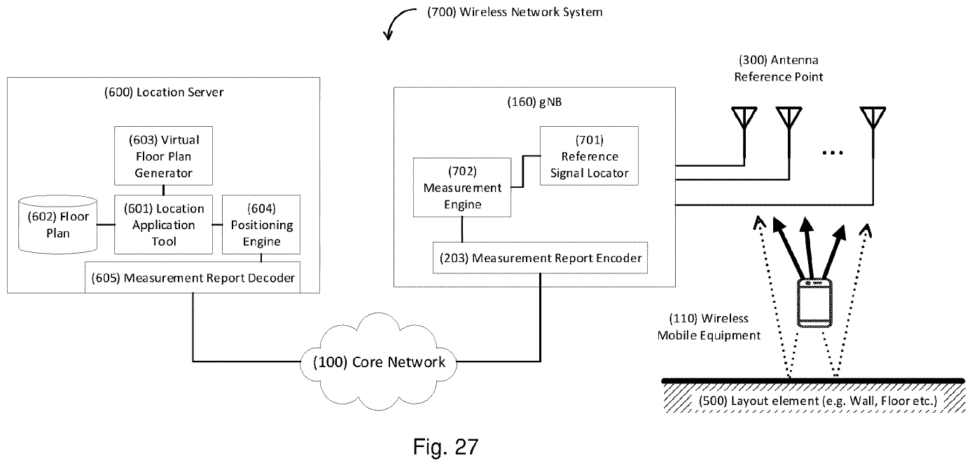

FIG. 27 is a block diagram illustrating an example wireless network positioning system, according to particular embodiments. A wireless network positioning system 700 consists of at least some of the illustrated subsystems, from right to left: a mobile wireless device 110, a venue that includes structures such as walls 500, an array of antenna reference points 300, a wireless signal processing equipment such as a gNB 160, a core network 100 and a location server 600.

In first phase of operation, the wireless device generates a radio frequency (RF) signature. Wireless device 110 transmits an uplink signal. The uplink signal is known by the system and the signal is received by the array of antenna reference point 300 either directly as line-of-sight reception or as non-line-of-sight signal reception after a reflection from one or more surrounding structures 500.

In a second phase of operation, the system performs signal processing on the received RF signal. Wireless signal processing equipment 160 receives the individual signal from each of the elements in the array of antenna reference point 300. Reference signal locator 701 knows the designated signal transmitted by wireless device 110. This technique is a proven technology for estimation of the RF channel.

Measurement engine 702 performs the signal processing algorithm to preserve the amplitude and phase of the received designated signal in both time and frequency by each of the elements in the array of antenna reference point 300. This large amount of data is packaged by measurement report encoder 703 as a standard protocol or other interface. The identification of the received designated signal by each of the ARP elements is tagged.

A third phase of operation includes transport of the measurement report. The measurement reports generated by measurement report encoder 203 are submitted to core network 100. They are encoded with the receiving addresses, which may be one or more of location Servers 600.

In a fourth phase of operation, the system performs multipath positioning difference of arrival on the received RF signal. Location application tool 601 has access to floor plan 602. Therefore, location application tool 601 has the knowledge of the deployment environment factors and the location of each of the array elements in antenna reference point 300. Location application tool 601 uses virtual floor plan generator 603 to model the environment and to create one or more virtual antenna reference points (vARPs) described above. This information is provided to positioning engine 604.

The measurement reports are interpreted by measurement report decoder 605. The information is analyzed by positioning engine 604, which uses any one or more of the positioning algorithms described above. A position report for wireless device 110 is calculated.

The multipath positioning difference of arrival algorithm may reside in any subsystem of location server 600 or any component inside the wireless network positioning system 700.

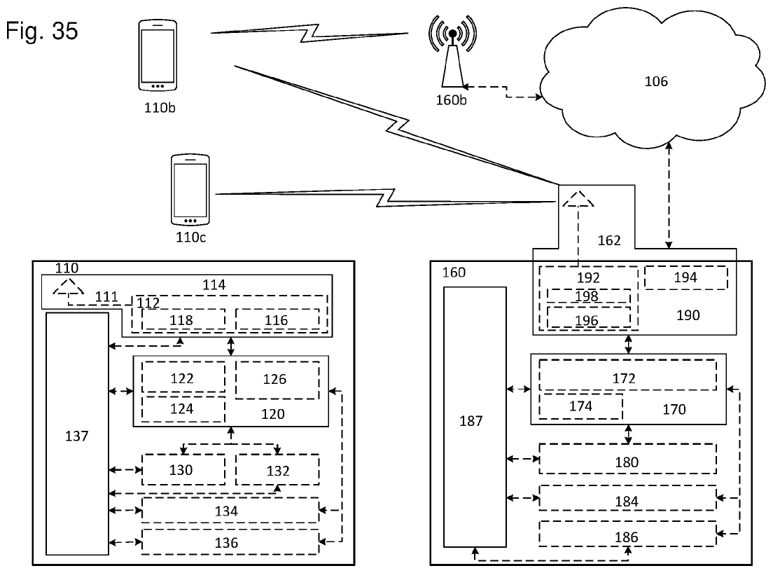

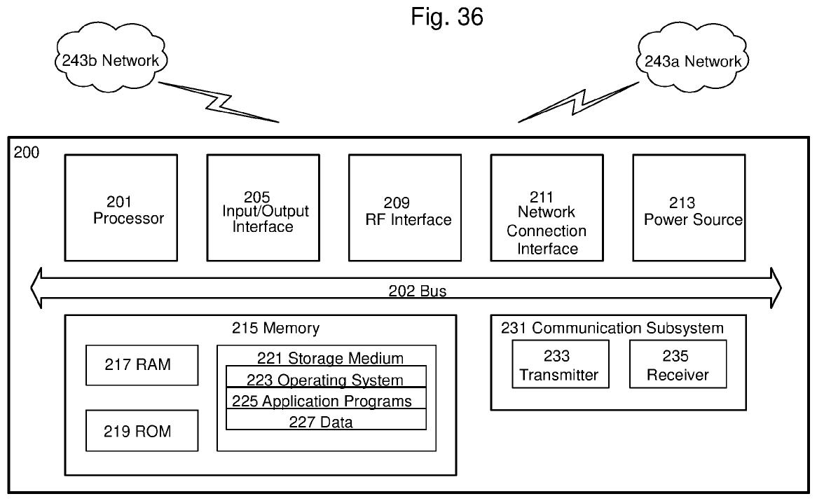

Some of the components of FIG. 27 are described in more detail with respect to FIGS. 35 and 36.

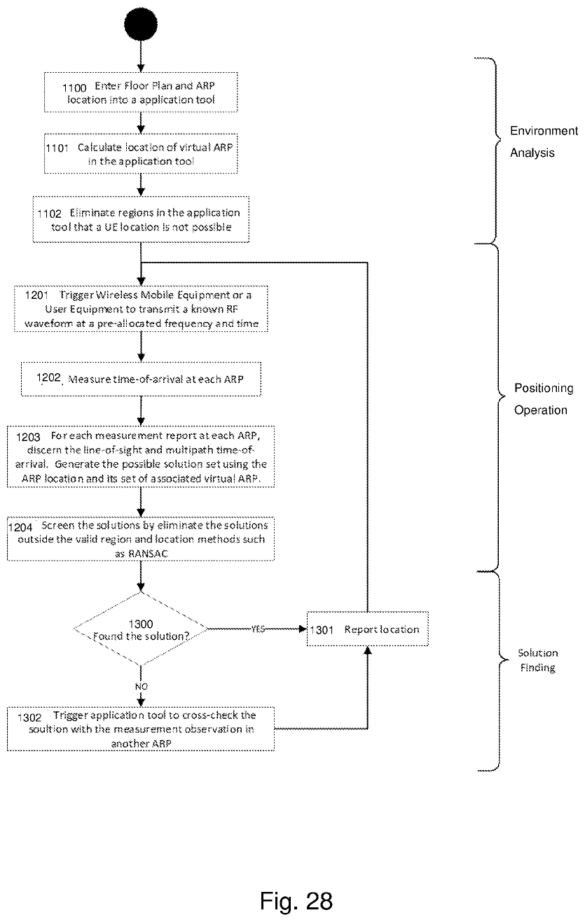

FIG. 28 is a flowchart illustrating an example positioning method, according to particular embodiments. The method may be performed by, for example network node 160 and/or location server 600 described with respect to FIGS. 27 and 35. The method is divided into three phases, the environment analysis phase, the positioning phase, and the solution finding phase.

In the environment analysis phase, at step 1100: the system analyzes the floor plan including the material and the geometry of the structures. The analysis also incorporates the location of the antenna reference point.

At step 1101, the system calculates the virtual antenna reference point projection and includes that in the model of the RF characteristic of the deployment venue. At step 1102, the system may mark the regions that the wireless device may be physically located. Areas outside of the region are not a possible solution for the wireless device location.

In the positioning phase, at step 1201 the system designates the RF signal that will be transmitted by the wireless device. If necessary, the system triggers the wireless device to transmit the predefined RF signal in a predetermined time and frequency.

At step 1202, the system monitors each of the elements in its one or more antenna reference points for the predefined RF signal. At step 1203, the system analyzes the RF signal at each ARP and separates the individual line-of-sight component and non-line-of-sight multipath components. The system maps the RF signal characteristics, such as amplitude, phase, time and frequency into the ARPs and the vARPs and generates a group of possible wireless device position solutions.

At step 1204, the group of solutions are validated through the possible region described in step 1102. By eliminating the impossible solutions, a smaller subset of solutions is achieved. In addition to that, a positioning algorithm, such as RANSAC, may be applied to simplify the solution set further.

In the solution finding stage, at step 1300 if the system finds a unique solution, then the unique solution is the position of the wireless device and the method proceeds to step 1301. Otherwise, a further step 1302 is needed.

Step 1301 prepares the position report of the wireless device. The system is ready to repeat the process for another measurement of the same or different wireless device.

At step 1302, if the system cannot conclude the position of the wireless device with one ARP, the system may use results from one or more additional ARPs to reduce the solution set further to arrive at a unique solution. The ambiguity resolution is described in the embodiments above.

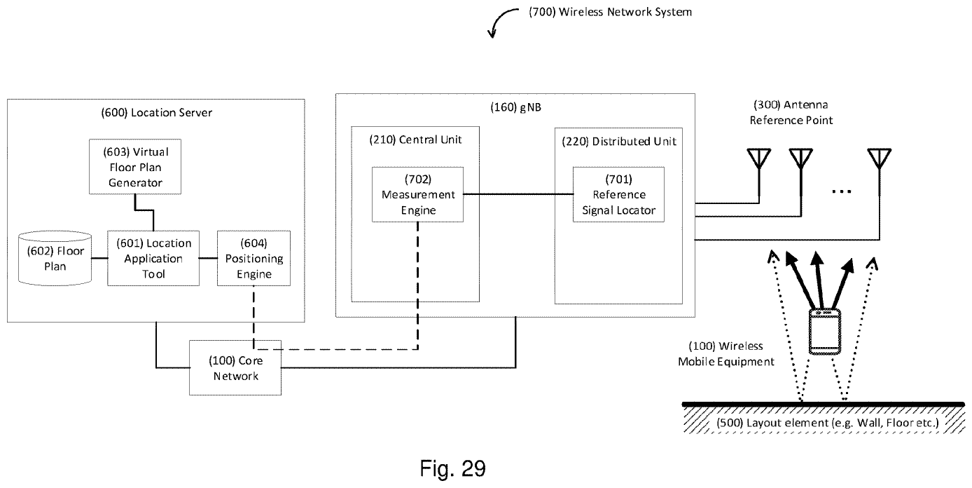

In some embodiments, some or all of the components described above may reside in the cloud or an Open-RAN (O-RAN) environment. The cloud implementation of particular embodiments may be realized in a distributed system or centrally located. FIGS. 29-33 illustrate five potential cloud configurations, however other variations of these configurations are apparent to one of skill in the art.

FIG. 29 is block diagram illustrating a distributed position algorithm in a cloudified wireless signal processor. The position algorithm may be distributed across multiple nodes in a cloud RAN, as illustrated.

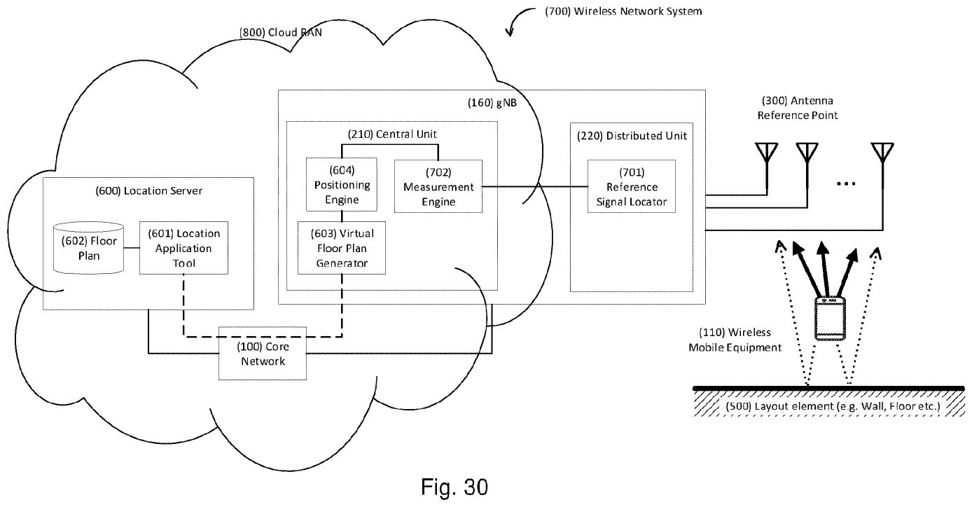

FIG. 30 is a block diagram illustrating a centralized position algorithm in a cloudified wireless signal processor. The position algorithm may be centrally located inside the cloudified part of a wireless signal processor in a cloud RAN, as illustrated.

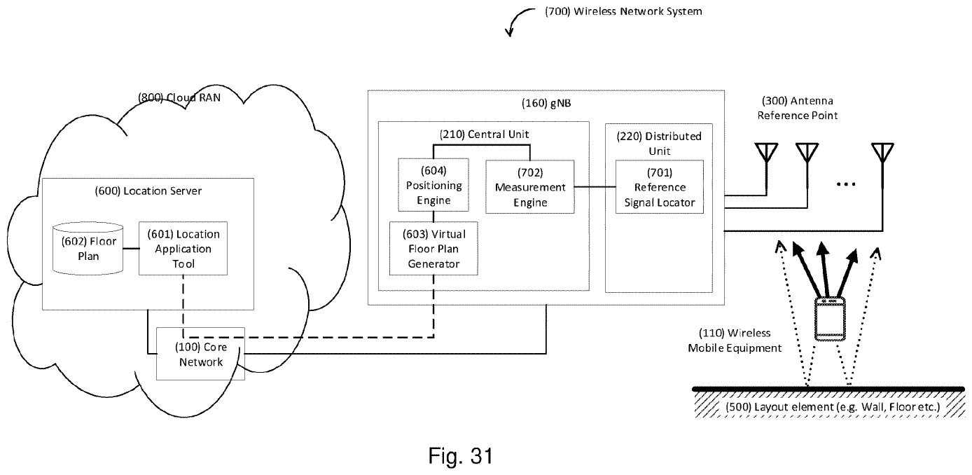

FIG. 31 is a block diagram illustrating a position algorithm in a wireless signal processor at the network edge. The position algorithm may be centrally located at the edge node of a cloud RAN, as illustrated.

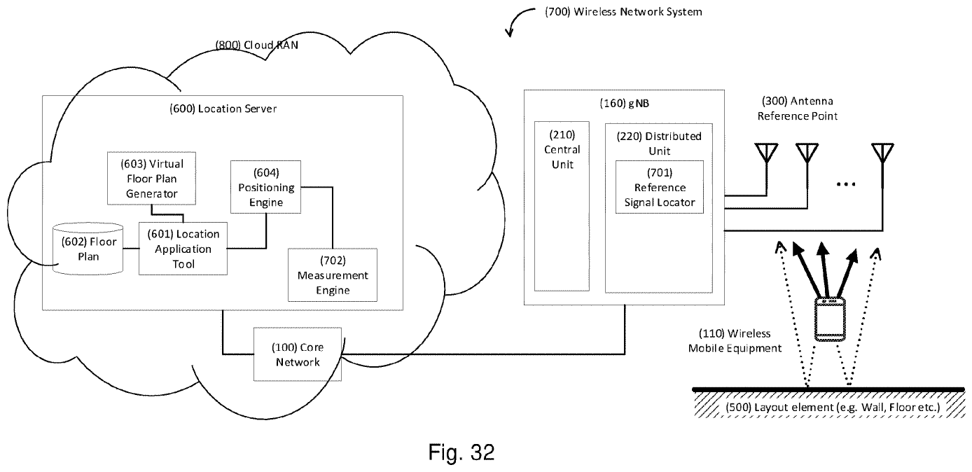

FIG. 32 is a block diagram illustrating a position algorithm in a cloudified location server. The position algorithm may be centrally located inside the cloudified location server in a cloud RAN, as illustrated.

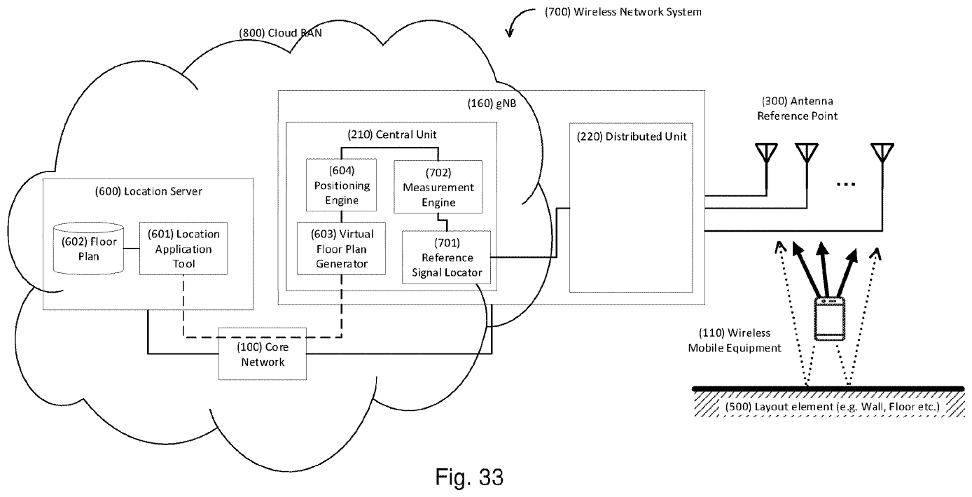

FIG. 33 is a block diagram illustrating a position algorithm in a cloudified central unit of wireless signal processor. The position algorithm may be centrally located inside the cloudified part of a wireless signal processor in a cloud RAN, as illustrated. In this scenario the reference signal comparison is not in the edge node, however it is contained in part of the cloud RAN.

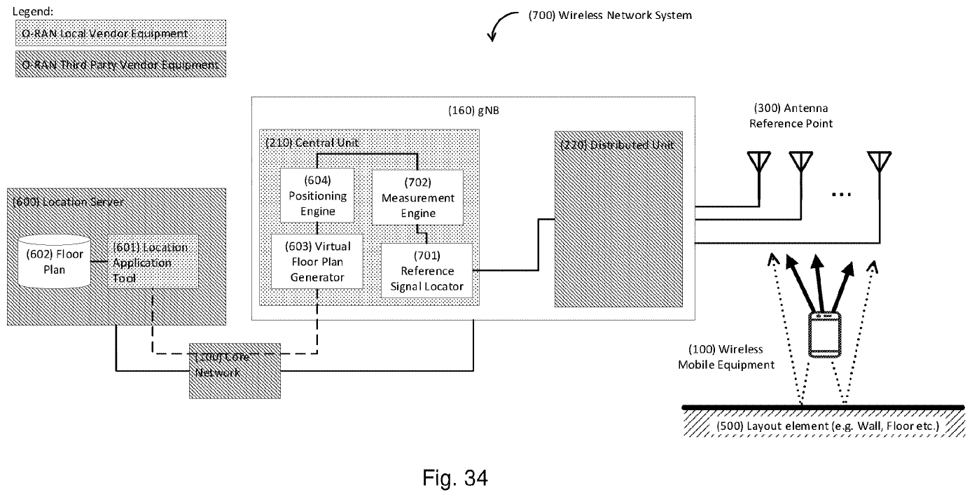

Some embodiments include O-RAN implementation. An example is illustrated in FIG. 34.

FIG. 34 is a block diagram illustrating an example position algorithm in an O-RAN environment. In the illustrated example, the gNB Distributed Unit, such as the radio and the uplink lower layer protocol stack may be an O-RAN third party vendor, as long as the information on the RF multipath signal representation at the antenna reference point is preserved.

The signal processing and analysis may be maintained in the Central Unit, which implements the positioning algorithms described herein. The Core Network may be an equipment from any O-RAN third party vendor. The Location Server may be an equipment from any O-RAN third party vendor. Some embodiments may include a software application to facilitate presentation of the wireless device location information.

In some embodiments, the measurements described above may be passed in an NRPPa Location Information Transfer Procedure. 3GPP defines generalized message information for location management functions. The Location Information Transfer/Assistance Data Transfer Procedure is one example where information such as that listed in Table 8.13.2.2—that includes measurement results that may be transferred from gNBs to the LMF (see: ETSI TS 138 305 V17.0.0 (2022 May)). This table includes up-link relative time of arrivals. However, UL-RToA is a small set of information, and limited, because a single value cannot be used for virtual ARP positioning. Thus, particular embodiments include additional nLoS ToA and nLoS carrier phase measurements that are reported by the gNB to the LMF.

Another reference is ETSI TS 138 455 V 16.1.0 (2020 November), which defines the fields for the measurement data. Section 9.1.4 specifies “Messages for Measurement Information Transfer Procedures” and details measurement requests and reports containing, amongst other elements: ULRTOA. However, this report does not include nLoS measurements associated with vARPs. Particular embodiments include updated requests and reports that include fields for nLoS ToA and nLoS carrier phase measurements.

FIG. 35 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 35, network node 160 includes processing circuitry 170, device readable medium 180, interface 190, auxiliary equipment 184, power source 186, power circuitry 187, and antenna 162. Although network node 160 illustrated in the example wireless network of FIG. 35 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 35 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless camera, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IOT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 35. For simplicity, the wireless network of FIG. 35 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

FIG. 36 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 36, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 36 is a UE, the components discussed herein are equally applicable to a WD, and vice-versa.

In FIG. 36, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 36, or only a subset of the components. The level of integration between the components may vary from one UE to another UE. Further, certain UEs may contain multiple instances of a component, such as multiple processors, memories, transceivers, transmitters, receivers, etc.

In FIG. 36, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 36, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 36, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

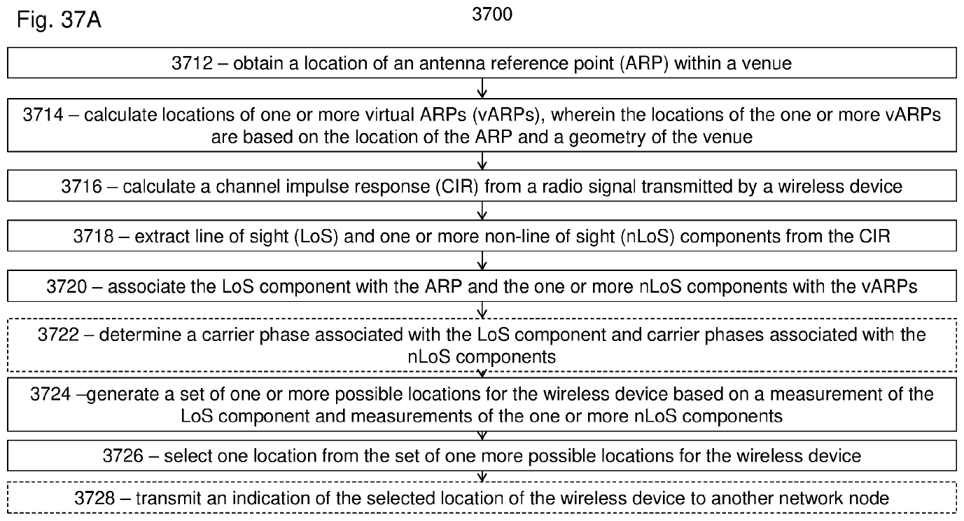

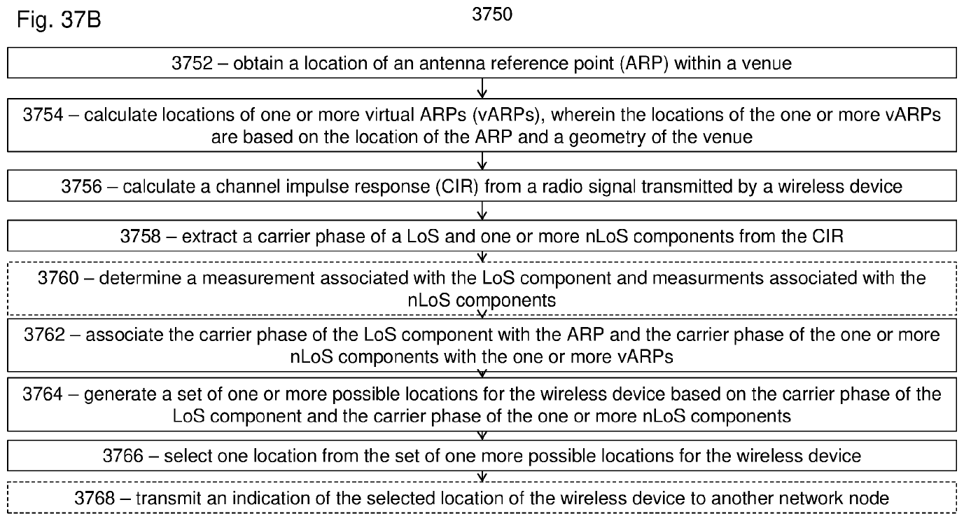

FIG. 37A is a flowchart illustrating an example method in a network node, according to certain embodiments. In particular embodiments, one or more steps of FIG. 37A may be performed by network node 160 described with respect to FIG. 35. In some embodiments, one or more steps of FIG. 37A may be performed by another network node, such as a core network node or any suitable server or processor, such as a location server. In general, method 3700 comprises locating a wireless device.

The method begins at step 3712, where the network node (e.g., network node 160) obtains a location of an ARP (e.g., network node, antenna, radio, etc.) within a venue. The venue may comprise a room within a building, an entire floor of a building, a warehouse, any indoor or outdoor space with walls or ceilings, or any structure or location that comprises objects or features that reflect RF signals. The network node may obtain the location of the ARP through operator provisioning or the network node may determine the location autonomously. The network node may obtain the location according to any of the embodiments and examples described herein.

At step 3714, the network node calculates locations of one or more vARPs. The locations of the one or more vARPs are based on the location of the ARP and a geometry of the venue. In particular embodiments, the locations of one or more virtual ARPs with respect to the venue is further based on a construction material of the venue.

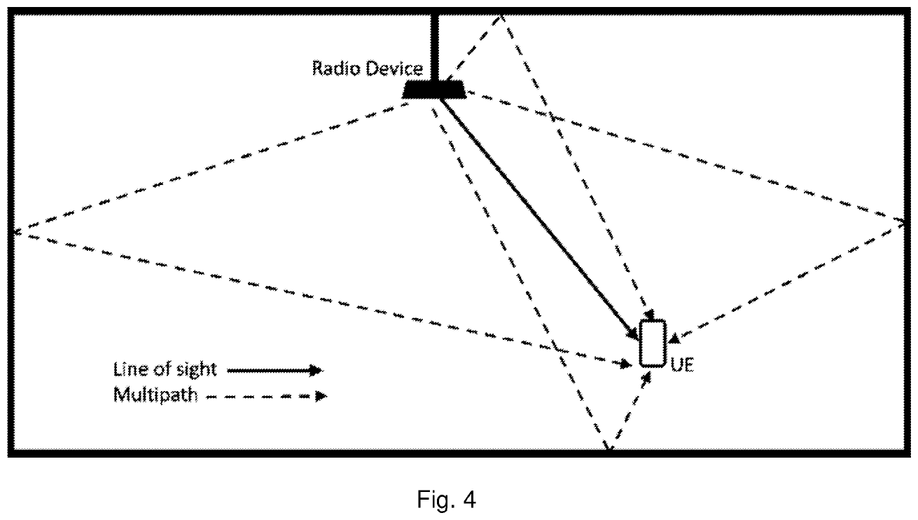

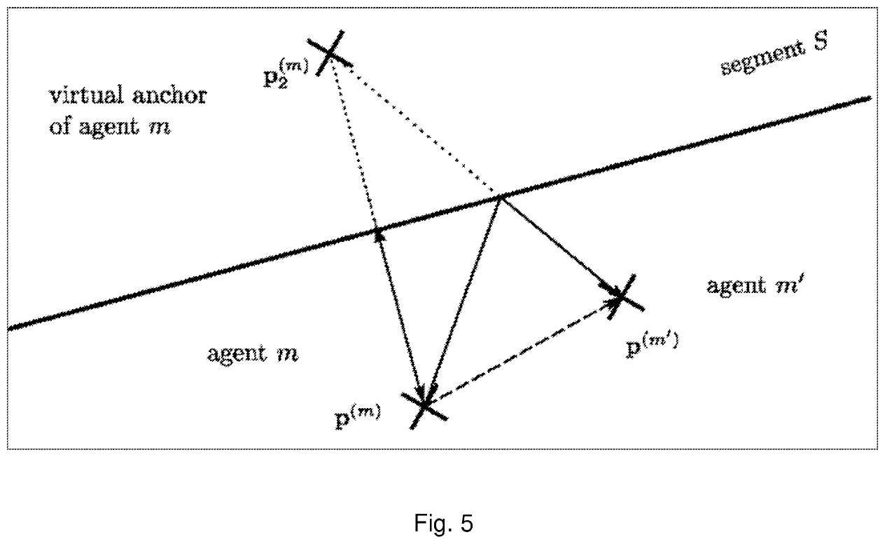

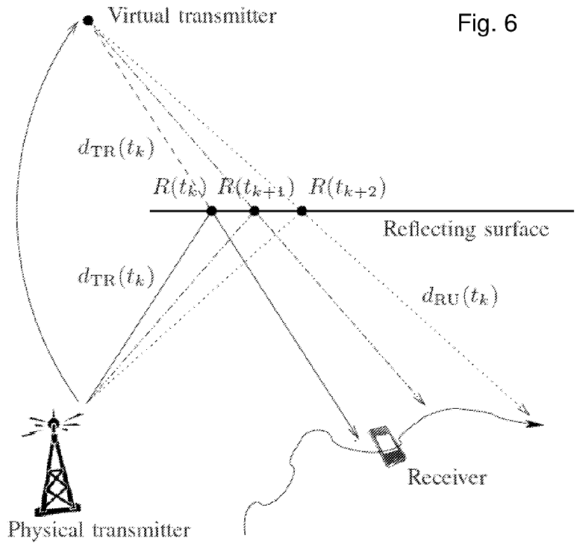

A vARP is located at a virtual location equidistant from a reflective surface (such as a wall, window) in the venue along a line orthogonal to the reflective surface. Examples are illustrated in FIGS. 4-10.

At step 3716, the network node calculates a CIR from a radio signal transmitted by a wireless device. The CIR includes a LOS component and one or more nLoS components.

At step 3718, the network node extracts the LoS and one or more nLoS components from the CIR, and at step 3720 the network node associates the LoS component with the ARP and the one or more nLoS components with the one or more vARPs. The network node may associate the LoS with the ARP and the nLoS with the vARP according to any of the embodiments and examples described herein (see FIGS. 10-19 and related description).

At step 3722, the network node may determine a carrier phase associated with the LoS component and carrier phases associated with one or more of the nLoS components. The network node may determine the carrier phase according to any of the embodiments and examples described above.

At step 3724, the network node generates a set of one or more possible locations for the wireless device based on a measurement of the LoS component and measurements of the one or more nLoS components. In particular embodiments, the measurement associated with the LoS component and the measurements associated with one or more of the nLoS components comprises a time of flight (ToF) measurement, or a time difference of arrival (TDoA) measurement. In particular embodiments, if the network node determined the carrier phases on the previous step, the network node may use the carrier phases to generate the set of one or more possible locations for the wireless device.

In some embodiments, the network node may transmit the measurement of the LoS component and measurements of the one or more nLoS components to a location management function (LMF).

The network node may generate the set of one or more possible locations for the wireless device based on intersecting circles or parabolas according to any of the embodiments and examples described herein (see FIGS. 10-19 and related description).

At step 3726, the network node selects one location from the set of one more possible locations for the wireless device. For example, as described above with respect to FIGS. 20 and 21, the multiple intersections may result in more than one possible location for the wireless device.

In particular embodiments, selecting one location from the set of one or more possible locations for the wireless device is based on a signal strength associated with one or more of the nLoS components. In some embodiments, selecting one location from the set of one or more possible locations for the wireless device comprises excluding possible solutions that locate the wireless device outside of the venue or excluding possible solutions that locate the wireless device within restricted areas of the venue. In some embodiments, selecting one location from the set of one or more possible locations for the wireless device is based on a previously determined location of the wireless device or finger printing of the wireless device. In some embodiments, selecting one location from the set of one or more possible locations for the wireless device comprises receiving measurement information from a second ARP. The network node may select one location from the set of one or more possible locations based on any of the embodiments and examples described herein.

In particular embodiments, the method further comprises transmitting an indication of the selected location of the wireless device to another network node. For example, to assist another network node select one location from a set of one or more possible locations for a wireless device, the network node may send information about ARPs, VARPs, measurements, and/or carrier phase to another network node so the other network may use the information in conjunction with its own information to determine a location of a wireless device.

Modifications, additions, or omissions may be made to method 3700 of FIG. 37A. Additionally, one or more steps in the method of FIG. 37A may be performed in parallel or in any suitable order.

FIG. 37B is a flowchart illustrating another example method in a network node, according to certain embodiments. In particular embodiments, one or more steps of FIG. 37B may be performed by network node 160 described with respect to FIG. 35. In some embodiments, one or more steps of FIG. 37B may be performed by another network node, such as a core network node or any suitable server or processor. In general, method 3700 comprises locating a wireless device.

The method begins at step 3752, where the network node (e.g., network node 160) obtains a location of an ARP within a venue and at step 3754 the network node calculates locations of one or more vARPs. The locations of the one or more vARPs are based on the location of the ARP and a geometry of the venue. At step 3756, the network node calculates a CIR from a radio signal transmitted by a wireless device. Steps 3752-3756 are similar to steps 3712-3716 described with respect to FIG. 37A.

At step 3758, the network node extracts a carrier phase of a LOS and one or more nLoS components from the CIR. The network node may extract the carrier phase according to any of the examples and embodiments described herein.

At step 3760, the network node may determine a measurement associated with the LoS component and measurements associated with one or more of the nLoS components. Step 3760 is similar to step 3720 described with respect to FIG. 37A.

At step 3762, the network node associates the carrier phase of the LoS component with the ARP and the carrier phase of the one or more nLoS components with the one or more vARPs. The network node associates the carrier phase of the LoS component with the ARP and the carrier phase of the one or more nLoS components according to any of the examples and embodiments described herein.

At step 3764, the network node generates a set of one or more possible locations for the wireless device based on the carrier phase of the LoS component and the carrier phase of the one or more nLoS components. In some embodiments, the wireless device may generate the set of one or more possible locations for the wireless device further based on the measurement associated with the LoS component and the measurements associated with one or more of the nLoS components.

In some embodiments, the network node may transmit the measurement of the carrier phase of the LoS component and measurements of the carrier phase of the one or more nLoS components to a LMF.

At step 3766, the network node selects one location from the set of one more possible locations for the wireless device. At step 3768 the network node may transmit an indication of the selected location of the wireless device to another network node. Steps 3766 and 3768 are similar to steps 3026 and 3028 described with respect to FIG. 37A.

Modifications, additions, or omissions may be made to method 3750 of FIG. 37B. Additionally, one or more steps in the method of FIG. 37B may be performed in parallel or in any suitable order.

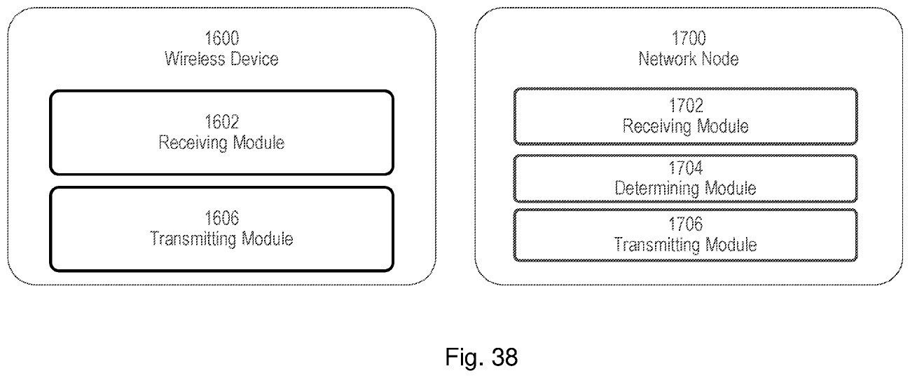

FIG. 38 illustrates a schematic block diagram of two apparatuses in a wireless network (for example, the wireless network illustrated in FIG. 36). The apparatuses include a wireless device and a network node (e.g., wireless device 110 and network node 160 illustrated in FIG. 36). Apparatus 1700 is operable to carry out the example methods described with reference to FIGS. 37A and 37B, and possibly any other processes or methods disclosed herein. It is also to be understood that the methods of FIGUREA 37A and 37B are not necessarily carried out solely by apparatus 1700. At least some operations of the methods may be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, transmitting module 1606, and any other suitable units of apparatus 1600 to perform corresponding functions according one or more embodiments of the present disclosure. Similarly, the processing circuitry described above may be used to cause receiving module 1702, determining module 1704, transmitting module 1706, and any other suitable units of apparatus 1700 to perform corresponding functions according one or more embodiments of the present disclosure.

As illustrated in FIG. 38, apparatus 1600 includes receiving module 1602 configured to receive configuration information for transmitting a measurement reference signal according to any of the embodiments and examples described herein. Transmitting module 1606 is configured to transmit a measurement reference signal according to any of the embodiments and examples described herein.

As illustrated in FIG. 38, apparatus 1700 includes receiving module 1702 configured receive a measurement signal from a wireless device. Determining module 1704 is configured to determine a location of the wireless device according to any of the embodiments and examples described herein. Transmitting module 1706 is configured to transmit a location report according to any of the embodiments and examples described herein.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a network node for determining a location of a wireless device, the method comprising:
obtaining a location of an antenna reference point (ARP) within a venue;
calculating locations of one or more virtual ARPs (vARPs), the locations of the one or more vARPs being based on the location of the ARP and a geometry of the venue;
calculating a channel impulse response (CIR) from a radio signal transmitted by a wireless device;
extracting line of sight (LoS) and one or more non-line of sight (nLoS) components from the CIR;
associating the LoS component with the ARP and the one or more nLoS components with the one or more vARPs;
generating a set of one or more possible locations for the wireless device based on a measurement of the LoS component and measurements of the one or more nLoS components; and
selecting one location from the set of one more possible locations for the wireless device.

2. The method of claim 1, further comprising determining a carrier phase associated with the LoS component and carrier phases associated with one or more of the nLoS components and wherein generating the set of one or more possible locations for the wireless device is further based on the carrier phase associated with the LoS component and the carrier phases associated with one or more of the nLoS components.

3. The method of claim 1, wherein the measurement associated with the LoS component and the measurements associated with one or more of the nLoS components comprises a time of flight (ToF) measurement.

4. The method of claim 1, wherein the measurement associated with the LoS component and the measurements associated with the one or more nLoS components comprises a time difference of arrival (TDoA) measurement.

5. The method of claim 1, wherein selecting one location from the set of one or more possible locations for the wireless device is based on a signal strength associated with one or more of the nLoS components.

6. The method of claim 1, wherein selecting one location from the set of one or more possible locations for the wireless device comprises excluding possible solutions that locate the wireless device outside of the venue.

7. method of claim 1, wherein selecting one location from the set of one or more possible locations for the wireless device comprises excluding possible solutions that locate the wireless device within restricted areas of the venue.

8. The method of claim 1, wherein selecting one location from the set of one or more possible locations for the wireless device is based on a previously determined location of the wireless device.

9. The method of claim 1, wherein selecting one location from the set of one or more possible locations for the wireless device is based on finger printing of the wireless device.

10. The method of claim 1, wherein selecting one location from the set of one or more possible locations for the wireless device comprises receiving measurement information from a second ARP.

11. The method of claim 1, wherein the locations of one or more virtual ARPs with respect to the venue is further based on a construction material of the venue.

12. The method of claim 1, further comprising transmitting an indication of the selected location of the wireless device to another network node.

13. A network node capable of determining a location of a wireless device, the network node comprising processing circuitry operable to:
obtain a location of an antenna reference point (ARP) within a venue;
calculate locations of one or more virtual ARPs (vARPs), the locations of the one or more vARPs being based on the location of the ARP and a geometry of the venue;
calculate a channel impulse response (CIR) from a radio signal transmitted by a wireless device;
extract line of sight (LoS) and one or more non-line of sight (nLoS) components from the CIR;
associate the LoS component with the ARP and the one or more nLoS components with the one or more vARPs;
generate a set of one or more possible locations for the wireless device based on a measurement of the LoS component and measurements of the one or more nLoS components; and
select one location from the set of one more possible locations for the wireless device.

14. The network node of claim 13, the processing circuitry further operable to determine a carrier phase associated with the LoS component and carrier phases associated with one or more of the nLoS components and wherein the processing circuitry is operable to generate the set of one or more possible locations for the wireless device is further based on the carrier phase associated with the LoS component and the carrier phases associated with one or more of the nLoS components.

15. The network node of claim 13, wherein the measurement associated with the LoS component and the measurements associated with one or more of the nLoS components comprises a time of flight (ToF) measurement.

16. The network node of claim 13, wherein the measurement associated with the LoS component and the measurements associated with the one or more nLoS components comprises a time difference of arrival (TDoA) measurement.

17. The network node of claim 13, wherein the processing circuitry is operable to select one location from the set of one or more possible locations for the wireless device based on a signal strength associated with one or more of the nLoS components.

18. The network node of claim 13, wherein the processing circuitry is operable to select one location from the set of one or more possible locations for the wireless device by excluding possible solutions that locate the wireless device outside of the venue.

19. The network node of claim 13, wherein the processing circuitry is operable to select one location from the set of one or more possible locations for the wireless device by excluding possible solutions that locate the wireless device within restricted areas of the venue.

20. The network node of claim 13, wherein the processing circuitry is operable to select one location from the set of one or more possible locations for the wireless device based on a previously determined location of the wireless device.

21.-50. (canceled)
